(19) United States
(12) Patent Application Publication
(10) Pub. No.: US 2025/0065967 A1
(43) Pub. Date: Feb. 27, 2025

(54) PASSIVELY ADAPTIVE LEGGED ROBOT WITH DIFFERENTIALS AND NON-BACKDRIVABLE PRISMATIC LEGS

(71) Applicant: Yale University, New Haven, CT (US)

(72) Inventors: Seonghoon Noh, New Haven, CT (US); Aaron Dollar, New Haven, CT (US); Oren Kanner, New Haven, CT (US)

(21) Appl. No.: 18/811,369

(22) Filed: Aug. 21, 2024

Related U.S. Application Data
(60) Provisional application No. 63/520,730, filed on Aug. 21, 2023.

(51) Int. Cl. B62D 57/032; B25J 9/10

(52) U.S. Cl. CPC B62D 57/032; B25J 9/102

(57) ABSTRACT

A legged robot system has a medial body with first and second ends, slidably and rotatably attached to a lateral body with first and second ends via a locomotion mechanism configured to provide at least first and second degrees of freedom of movement for the lateral body relative to the medial body, a plurality of prismatic legs extending downward from positions on the lateral or medial bodies, each leg having a drive mechanism for extending the leg, wherein the first leg provides a third degree of freedom relative to its position on the lateral or medial body, and the second leg provides a fourth degree of freedom relative to its position on the lateral or medial body, and a differential mechanism connecting the first and second legs providing a fifth degree of freedom of movement for the first and second leg relative to each other.

### CROSS-REFERENCE TO RELATED APPLICATIONS

This application claims priority to U.S. provisional application No. 63/520,730 filed on Aug. 21, 2023, incorporated herein by reference in its entirety.

### STATEMENT REGARDING FEDERALLY SPONSORED RESEARCH OR DEVELOPMENT

This invention was made with government support under 1637647 awarded by the National Science Foundation. The government has certain rights in the invention.

### BACKGROUND OF THE INVENTION

Legged robots continue to improve in capabilities through more efficient designs and more effective control strategies that push the limits of their operating environments. Beginning with the early days of the Raibert Hopper, researchers have explored various legged robot designs in the past decades that have come to mature in more recent years. The common physical structure of a modern legged robot includes a number of articulated 3-DoF RRR legs, usually four. As with many robotic systems, the maturation of these robot hardware has shifted much focus to investigating various control, estimation, and planning methods that can extract more performance out of the robot's physical system.

This class of legged robot hardware has undoubtedly proven capable of dynamic legged locomotion in various environments. Blind locomotion by the MIT Cheetah and the outdoor hike by the ANYmal to name a few, and robust recovery from the well-known push tests all indicate that these highly dynamic, fully actuated legged robots have made great progress towards real-world deployment. Real-world deployment, however, has other practical considerations. One of the major factors limiting a more widespread deployment is the power requirement of these legged robots. While efficient in actuation, legged locomotion is inherently a less efficient mode of transportation compared to wheels. Therefore, it remains to ask whether there exist other legged robot designs that can address these limitations while still achieving the primary objective of legged robots—to maneuver rough terrains where wheeled vehicles cannot. Decades of research in the design and control of legged robots have unlocked a large array of locomotion capabilities ranging from running at high speeds to negotiating challenging terrains. Drawing inspiration from terrestrial organisms, multi-legged robots resembling their biological counterparts emerged, assuming a similar morphology through mechanical design. Solutions to increase the speed and agility of these legged systems have been proposed, many of which again drew inspiration from external and internal attributes of legged animals such as their gaits, neuromuscular systems, and the underlying dynamics. Dynamical models such as the linear inverted pendulum (LIP) and the spring-loaded inverted pendulum (SLIP) models that capture the periodic motions of a walking or running organism have been crucial for studying the stability of legged systems and devising controllers for locomotion. All these research efforts have guided and shaped many modern legged robots, which are typically characterized by a leg design consisting of three revolute joints and complex control strategies that leverage optimization and machine learning techniques.

Although modern legged robots reach new frontiers every day, their fundamental approach to legged locomotion poses several practical challenges. By employing a leg mechanism with three degrees of freedom or sometimes more, the dimensionality of the physical system scales poorly with the number of legs. A system with higher dimensionality typically necessitates more complex modeling and analysis as well as the appropriate amount of computational resources to support them; otherwise, one is left to reduce, abstract, or simplify the system, much like the aforementioned dynamical models.

In a robotic system, this simple fact imposes multiple physical and computational constraints. For example, a typical quadruped robot carries around twelve actuators-one for each joint. This number is substantially higher than that of a robot manipulator with six or seven degrees of freedom, but a robot manipulator does not have to carry its own power source, underscoring the demanding requirements for a legged robot. To calculate optimal controls for a kinematically redundant system in real-time, many have presented methods to reduce the required online computations by relying on offline solutions or trainings, but this still requires a non-negligible amount of online computational power. Addressing these limitations may unveil new ways to reduce the overall weight, cost, power requirements, and computational complexity involved in operating a legged robot in the real world.

Throughout the evolution of legged robots, there have been designs that envisioned other choices of legs aside from rigid, articulated three degrees-of-freedom legs. Mostly in the smaller-scale regime, legged robots that featured passively adaptive legs demonstrated high-speed locomotion with their hexapod configuration. RHex, Sprawlita, and Wheg robots embodied the idea of mechanical intelligence in which the passive dynamics of a physical system can respond to a disturbance faster than active feedback control. The compliance in their leg structure and a fixed, periodic actuation proved to be robust to disturbances from contacts with rough terrains. Although different from other legged robots in that terrain adaptability emerged from the inherent mechanical structure, these passively adaptive legged robots share the common property that the legs perform the task of locomotion and handle the accompanying constraints.

Thus, there is a need in the art for a legged robot system that enables efficient locomotion, terrain adaptability, and reduced power consumption. The present invention meets this need.

### SUMMARY OF THE INVENTION

Aspects of the present invention relate to a legged robot system having a medial body with first and second ends, slidably and rotatably attached to a lateral body with first and second ends via a locomotion mechanism configured to provide at least first and second degrees of freedom of movement for the lateral body relative to the medial body, a plurality of prismatic legs including first and second legs extending downward from positions on the first or second ends of the lateral or medial bodies, each leg having a drive mechanism for extending the leg, wherein the first leg provides a third degree of freedom relative to its position on the lateral or medial body, and the second leg provides a fourth degree of freedom relative to its position on the lateral or medial body, and a differential mechanism connecting the first and second legs providing a fifth degree of freedom of movement for the first and second leg relative to each other.

In some embodiments, the locomotion mechanism slidably and rotatably attaches a central portion of the medial body to a central portion of the lateral body. In some embodiments, the first degree of freedom is rotational, and the second degree of freedom is translational. In some embodiments, the third and fourth degrees of freedom are translational. In some embodiments, the fifth degree of freedom is translational or rotational. In some embodiments, the first, second, third and fourth degrees of freedom are constrained, and the fifth degree of freedom is unconstrained.

In some embodiments, the differential mechanism comprises an input shaft and first and second output shafts. In some embodiments, the system includes a first motor connected to the input shaft of the differential mechanism.

In some embodiments, the system includes a pair of non-backdrivable worm gearboxes, wherein a first worm gearbox connects the first output shaft of the differential mechanism to the drive mechanism of the first leg, and a second worm gearbox connects the second output shaft of the differential mechanism to the drive mechanism of the second leg. In some embodiments, each non-backdrivable worm gearbox comprises an actuator configured to selectively actuate the non-backdrivability of the worm gearbox.

In some embodiments, the differential mechanism comprises an electronically controlled limited-slip differential (LSD). In some embodiments, the first leg is configured to be at least partially actuated separately from the second leg.

In some embodiments, the first leg comprises a drive belt extending along at least a portion of a length of the first leg. In some embodiments, the drive mechanism comprises a drive gear for driving the drive belt. In some embodiments, the drive mechanism comprise an idler gear for aligning and tensioning the drive belt. In some embodiments, the first leg has a bottom compliant foot.

In some embodiments, the locomotion mechanism comprises a rack and pinion coupled to a rotatable gear, wherein the rack and pinion is configured to provide the translational movement, and the rotatable gear is configured to provide the rotational movement. In some embodiments, the system includes a second motor connected to the rack and pinion configured to actuate the rack and pinion, and a third motor connected to the rotatable gear configured to actuate the rotatable gear.

In some embodiments, the first, second and third motors each comprise one or more sensors selected from the group consisting of position sensor, speed sensor, power sensor, and torque sensor. In some embodiments, the system includes a computing device communicatively connected to the first, second and third motors, and the one or more sensors, the computing device configured to actuate the motors and capture signals from each of the one or more sensors.

### BRIEF DESCRIPTION OF THE DRAWINGS

The following detailed description of embodiments of the invention will be better understood when read in conjunction with the appended drawings. It should be understood, however, that the invention is not limited to the precise arrangements and instrumentalities of the embodiments shown in the drawings.

FIG. 1A depicts a perspective view of an exemplary legged robot system comprising medial and lateral bodies and passively adaptable non-backdrivable legs according to aspects of the present invention.

FIG. 1B depicts a perspective view of the system of FIG. 1A highlighting the lateral body rotating relative to the medial body with the legs hidden.

FIG. 1C depicts a side view of the legged robot system of FIG. 1A highlighting the lateral body translating relative to the medial body with the legs hidden.

FIG. 2A depicts an exploded view of an exemplary locomotion mechanism that attaches the medial and lateral body and provides multiple degrees of freedom of movement.

FIG. 2B depicts a bottom perspective view of an exemplary frame portion for the locomotion mechanism of FIG. 2A.

FIG. 3A depicts a side view of an exemplary leg (e.g., prismatic leg) comprising an actuator or drive mechanism with a non-backdrivable gear box, differential, and motor.

FIG. 3B depicts a side view of an exemplary pair of legs and actuators attached to output shafts of a differential, with non-backdrivable gear boxes positioned between the actuators and output shafts.

FIG. 3C is a series of images depicting side views of exemplary pairs of legs displaying the passive adaptability of the legs on uneven terrain.

FIG. 4A depicts a perspective view of an exemplary differential for powering an actuator and controlling a pair of legs according to aspects of the present invention.

FIG. 4B depicts a perspective view of a non-backdrivable gearbox positioned between each leg and actuator according to aspects of the present invention.

FIG. 5A depicts a perspective view of an exemplary medial body connected to a lateral body via a locomotion mechanism enabling rotational and translational degrees of freedom of movement.

FIG. 5B depicts a side view of an exemplary locomotion mechanism comprising a rack and pinion in the translational mechanism and the 6:1 spur gear train (e.g. one or more rotatable gears) in the rotational mechanism according to aspects of the present invention.

FIG. 5C depicts perspective views of an exemplary leg and actuator (left), and non-backdrivable gearbox (right) according to aspects of the present invention.

FIG. 5D depicts a perspective view of an exemplary differential for driving a pair of legs and actuators comprising a motor, input shaft, spur gears, differential carrier or housing, miter gears, and the gear differential's two output shafts according to aspects of the present invention.

FIG. 6 is a diagram of an exemplary computing device.

FIG. 7A depicts an exemplary legged robot system walking over a rough terrain obstacle course.

FIG. 7B depicts an exemplary legged robot system walking over rough terrain.

FIGS. 8A-8D are images and graphs depicting motor and joint trajectories during gait phases of the disclosed legged robot. Shaded regions of the graphs indicate the lateral body swing phase, and unshaded regions indicate the medial body swing phase. FIG. 8A depicts how open-loop torque control of the leg motors on the medial body drives the swing legs downward until they contact the terrain at different heights. The leg motor ramps up its torque during startup and then maintains a lower torque for the remainder of touchdown. FIG. 8B depicts how the translation motor slides the lateral body forward as its swing legs retract. FIG. 8C depicts how the lateral body now uses the same leg control strategy for its touchdown phase. FIG. 8D depicts how the translational joint travels in the other direction for the swing phase of the medial body.

FIG. 9A-9E depict the disclosed legged robot's passive adaptability to ground contact, and body perturbation during contact. FIG. 9A shows virtual legs (in blue) formed by the disclosed mechanically intelligent leg units. FIG. 9B shows virtual legs (in grey) formed by legs on the same sides of gear differentials. FIG. 9C is a plot showing distribution of leg stroke differences upon contact in the four mechanically intelligent leg units during locomotion over an indoor obstacle course. FIG. 9D is a plot showing body perturbation as measured by the greater of roll and pitch displacements during touchdown for medial and lateral bodies. FIG. 9E is a plot showing body angular displacement in the same plane as the differential motion of corresponding legs or virtual legs during contact.

FIGS. 10A-10F show the effects of underactuation on pose regulating motions of the disclosed robot. FIG. 10A is an image of the disclosed robot controlling its pitch while standing on rough terrain. FIG. 10B is a plot showing all cases of pitch control and the accompanied parasitic roll displacement during rough terrain locomotion testing with a vertical spread of the data points. FIG. 10C is a set of plots showing body roll and pitch, leg actuator position and medial body leg trajectories over time during a pitch control maneuver. FIG. 10D is an image of the disclosed robot showing when the body pitch exceeds an allowable value, with the robot controlling its roll while standing on rough terrain. FIG. 10E is a plot showing all cases of roll control and the accompanied parasitic pitch displacement during rough terrain locomotion testing. FIG. 10F is a set of plots showing body roll and pitch, leg actuator position and lateral body leg trajectories over time during a roll control maneuver.

FIGS. 11A-11E are images and correlating plots depicting outdoor locomotion of the disclosed legged robot. FIG. 11A is an image of an exemplary legged robot walking down a grass hill. Because of the downward terrain slope, the robot lowers its body during stance phase to regulate its height. FIG. 11B is an image of a legged robot walking on a hiking trail. Passive adaptability of the prismatic legs allows the body to stand on unknown terrain surfaces and maintain a level body posture during locomotion. FIG. 11C is an image of a legged robot walking in the woods. Sufficient swing leg retraction enables the robot to clear the fallen tree, step over it, and continue walking without knowledge of any obstacles. FIG. 11D is an image of an exemplary legged robot turning in place. The robot uses its passive adaptability and proprioceptive sensing of its body orientation to stay level while turning in place on a hill. FIG. 11E is a set of plots showing leg position vs time for outdoor locomotion of the legged robot in FIGS. 11A-11D.

FIGS. 12A-12E are plots and images showing normalized energy stability margin during locomotion and tipover detection and recovery of the disclosed legged robot. FIG. 12A is a set of plots showing terrain slope estimated through ground contacts, translational joint position and body height over local terrain over time. The range of motion of the translational joint is adjusted with the terrain slope to prevent the normalized energy stability margin of the robot from decreasing too much and tipping over. FIG. 12B is a set of plots showing normalized energy stability margin (NESM) surface of the robot as it translates its body forward (left to right). At the end of the translational motion, the robot configuration reaches the maximum possible stability margin given the current footholds. FIG. 12C is a set of images showing an exemplary legged robot displaying that the front of the robot can translate back and forth within the yellow range. FIG. 12D is a set of plots showing body Euler angle vs. time of the disclosed legged robot. FIG. 12E is an image of the disclosed legged robot during tipover (left) and a set of plots showing pitch displacement during tipover over roll displacement during tipover (middle) and NESM at the start of the tipover over roll displacement during tipover (right).

FIGS. 13A-13D are a set of images and plots displaying power characteristics of the disclosed legged robot. FIG. 13A is an image and plots depicting the disclosed legged robot walking on flat terrain (left) with plots displaying power consumption of the leg motors over one gait cycle (middle), and average power consumption of the different motors (right). FIG. 13B is an image and plots depicting the disclosed legged robot walking on rough terrain (left) with plots displaying power consumption of the leg motors over one gait cycle (middle), and average power consumption of the different motors (right) and rough terrains. FIG. 13C is a plot showing average power consumption of different motors for different terrain types. FIG. 13D is a set of plots showing average power consumption (left) and cost of transport (right) of the disclosed robot over different terrains.

### DETAILED DESCRIPTION

It is to be understood that the figures and descriptions of the present invention have been simplified to illustrate elements that are relevant for a clear understanding of the present invention, while eliminating, for the purpose of clarity many other elements found in related systems and methods. Those of ordinary skill in the art may recognize that other elements and/or steps are desirable and/or required in implementing the present invention. However, because such elements and steps are well known in the art, and because they do not facilitate a better understanding of the present invention, a discussion of such elements and steps is not provided herein. The disclosure herein is directed to all such variations and modifications to such elements and methods known to those skilled in the art.

### Definitions

Unless defined otherwise, all technical and scientific terms used herein have the same meaning as commonly understood by one of ordinary skill in the art to which the invention pertains. Although any methods and materials similar or equivalent to those described herein can be used in the practice for testing of the present invention, exemplary materials and methods are described herein. In describing and claiming the present invention, the following terminology will be used.

It is also to be understood that the terminology used herein is for the purpose of describing particular embodiments only, and is not intended to be limiting.

The articles “a” and “an” are used herein to refer to one or to more than one (i.e., to at least one) of the grammatical object of the article. By way of example, “an element” means one element or more than one element.

“About” as used herein when referring to a measurable value such as an amount, a temporal duration, and the like, is meant to encompass variations of +20%, +10%, +5%, +1%, or +0.1% from the specified value, as such variations are appropriate.

Ranges: throughout this disclosure, various aspects of the invention can be presented in a range format. It should be understood that the description in range format is merely for convenience and brevity and should not be construed as an inflexible limitation on the scope of the invention. Accordingly, the description of a range should be considered to have specifically disclosed all the possible subranges as well as individual numerical values within that range. For example, description of a range such as from 1 to 6 should be considered to have specifically disclosed subranges such as from 1 to 3, from 1 to 4, from 1 to 5, from 2 to 4, from 2 to 6, from 3 to 6 etc., as well as individual numbers within that range, for example, 1, 2, 2.7, 3, 4, 5, 5.3, and 6. This applies regardless of the breadth of the range.

Passively Adaptive Legged Robot with Gear Differentials and Non-Backdrivable Prismatic Legs

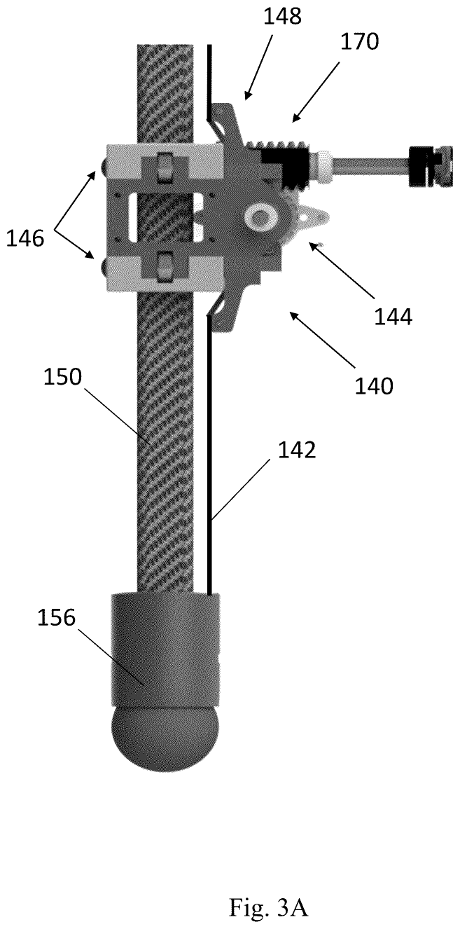

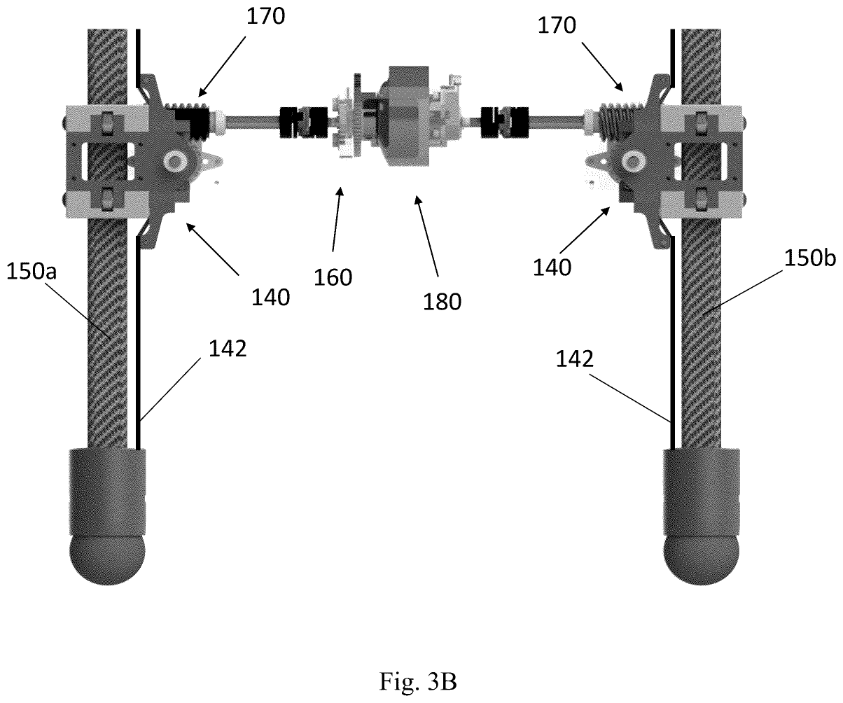

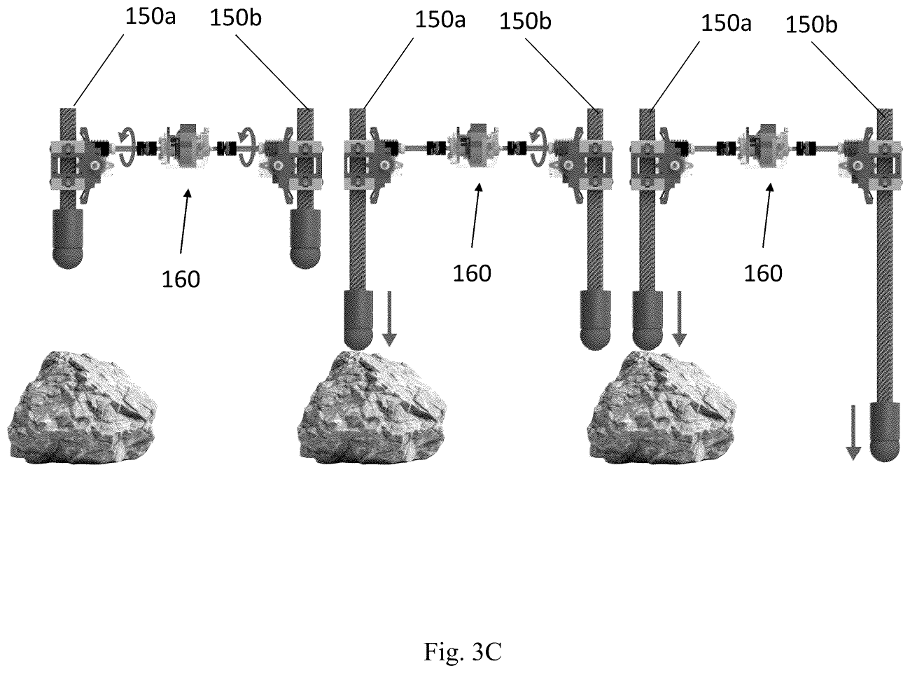

Disclosed herein is a passively adaptive legged robot system, in some examples a full-mobility octopod legged robot that achieves terrain locomotion with simple control strategies and proprioceptive sensing. Generally, the disclosed legged robot comprises at least two distinct bodies or frames that can move relative to each other within multiple degrees of freedom (e.g., translational and rotational) via a locomotion mechanism, and a plurality of legs (e.g., eight vertical prismatic legs) controlled by actuators attached to each body. In some embodiments, underactuated mechanisms or actuators drive or control the legs enabling passive adaptive locomotion that adapts to various terrains. The configuration also allows the disclosed robot to use far fewer actuators than other multi-legged robots. Despite the reduced degrees of actuation, the robot's multi-leg stance maintains static stability and resists reconfiguration during actuation due to the non-backdrivability of gears boxes (e.g., worm gears) driving the actuators. In some embodiments, pairs of actuators (and the correlating legs in some examples referred to as “mechanically intelligent leg units” or “leg units”) are coupled differentially through a differential (e.g., a gear differential) that enables one leg to passively touch down to a different terrain height after the first leg makes contact (see FIG. 3C). Each body of the robot has a set of legs (or one or more leg units) controlled by actuators. For movement or walking, the medial and lateral bodies translate and rotate with respect to one another, moving one set of legs relative to the other set of legs, enabling locomotion.

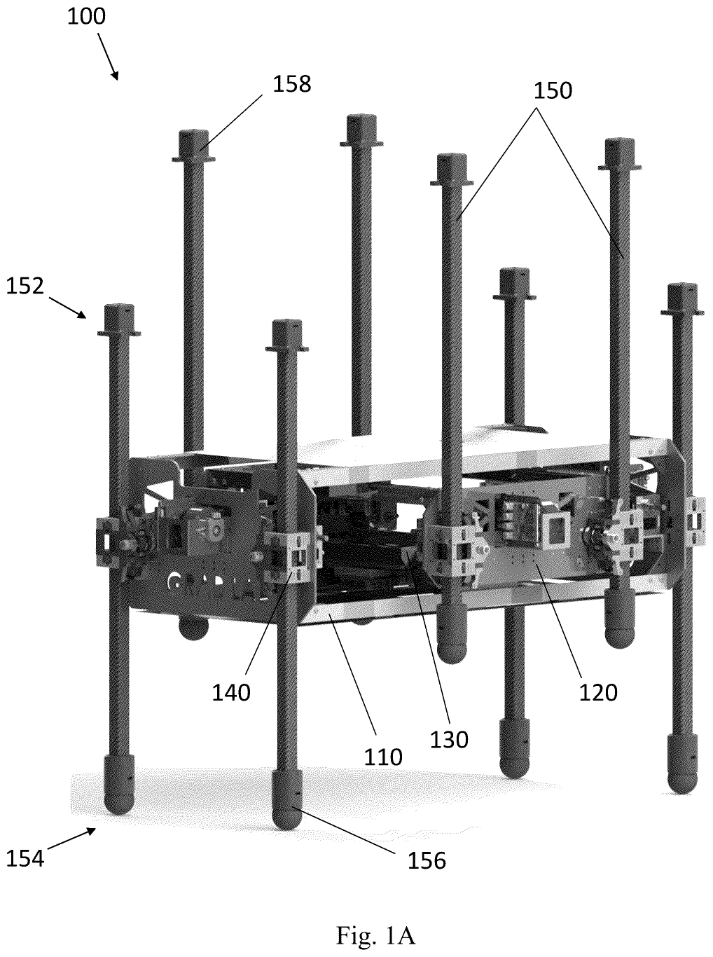

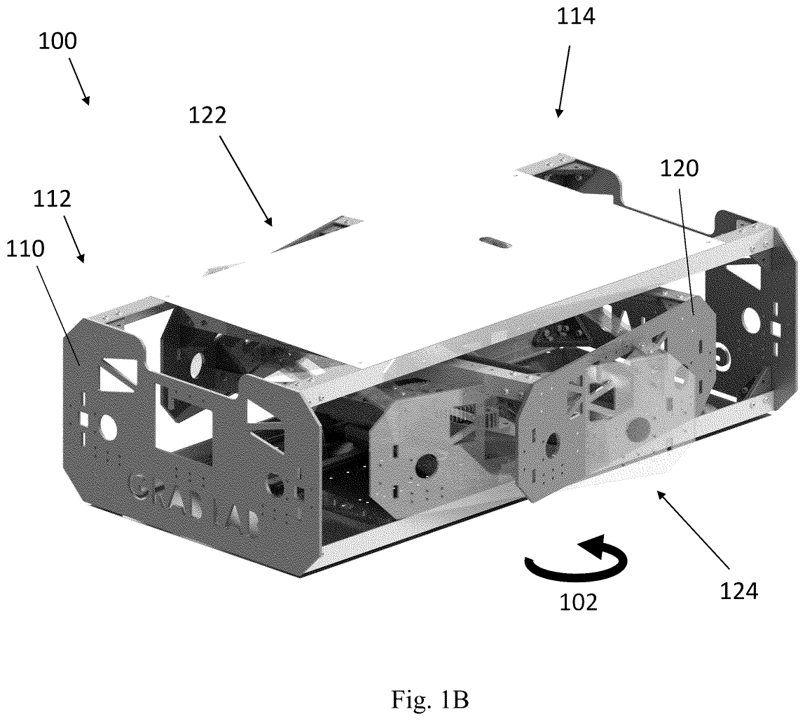

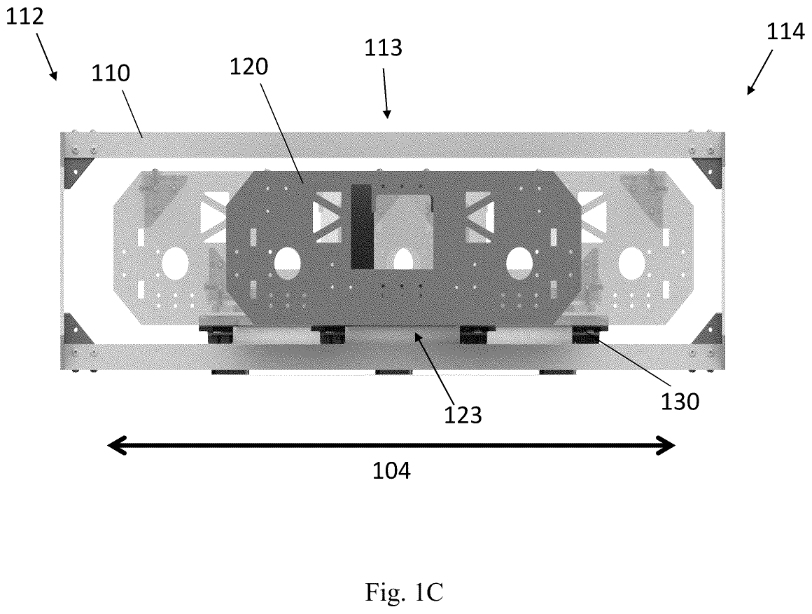

Aspects of the present invention relate to a passively adaptive legged robot or legged robot system 100. Referring now to FIGS. 1A-1C, shown is an exemplary system 100 comprising a first portion or medial body 110 attached or connected to a second portion or lateral body 120 via at least one locomotion mechanism 130. In some embodiments, medial body 110 comprises a first end 112, a central portion 113, and a second end 114, and lateral body 120 comprises a first end 122, a central portion 123, and a second end 124. In some embodiments, medial body 110 is slidably and rotatably attached or connected to lateral body 120 via locomotion mechanism 130. In some embodiments, locomotion mechanism 130 attaches or connects central portion 113 of medial body 110 to central portion 123 of the lateral body 120. In some embodiments, one or more actuators 140 with one or more legs 150 are positioned on each body. Medial body 110 and/or lateral body 120 may be formed of any material in any shape or size to provide sufficient stiffness to each body. Each body comprises one or more attachment points, positions, or interfaces for fixedly connecting to, or attaching to, other aspects of system 100 (e.g., locomotion mechanism 130, one or more actuators 140 and/or one or more legs 150).

The locomotion mechanism 130 allows medial body 110 to move, rotate and/or translate with at least one degree of freedom with respect to lateral body 120, or vice versa. FIG. 1B shows an axis of rotation 102 representing an exemplary rotational degree of freedom of movement for the bodies. FIG. 1C shows an axis 104 representing an exemplary translational degree of freedom of movement for the bodies. It should be appreciated that locomotion mechanism 130 may be configured to provide any number of degrees of freedom of movement between any number of connected bodies. In some embodiments, the locomotion mechanism is configured to provide at least first and second degrees of freedom of movement for at least a first body (e.g., lateral body 120) relative to a second body (e.g., medial body 110). In some embodiments, the locomotion mechanism may further be configured to provide at least a third degree of freedom of movement for at least a first body relative to a second body, for example roll, pitch, or translation in a vertical direction.

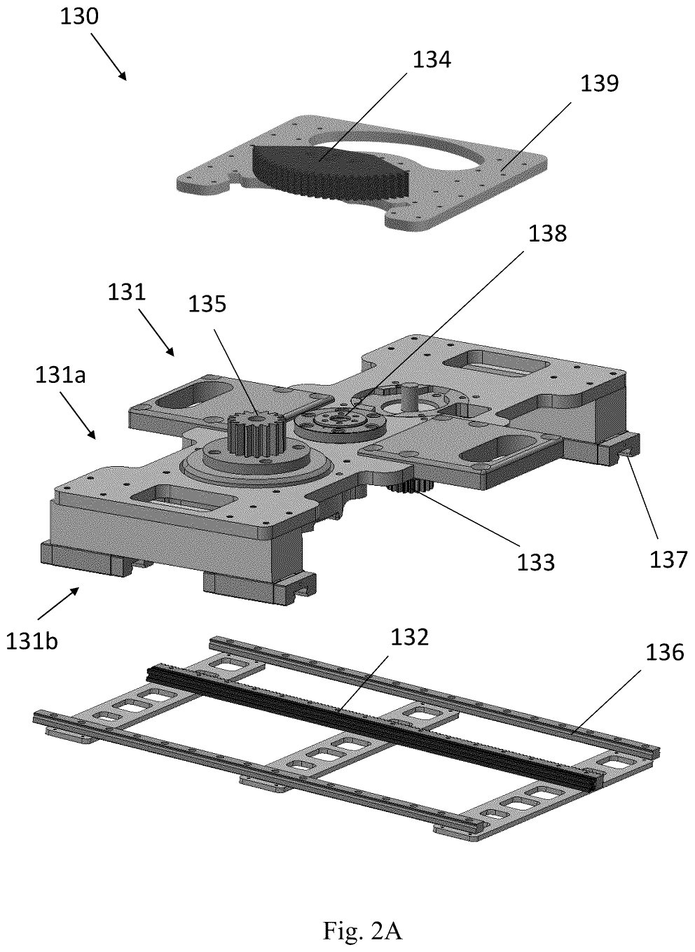

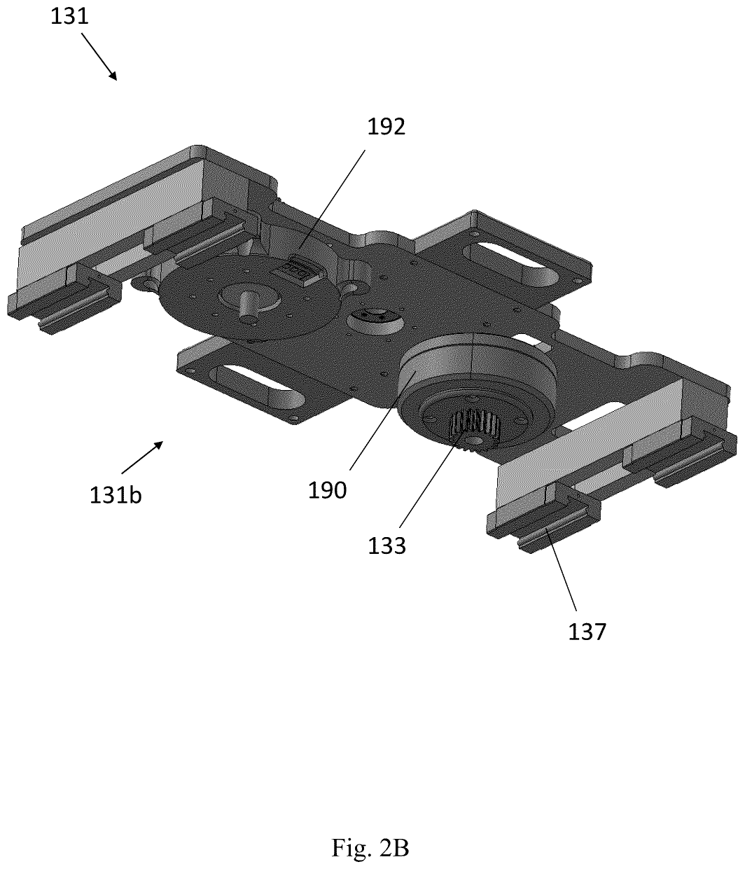

Referring now to FIG. 2A, shown is an exploded view of an exemplary locomotion mechanism 130 for system 100 according to aspects of the present invention. In some embodiments, locomotion mechanism 130 comprises a frame 131 having a top portion 131a and a bottom portion 131b. In some embodiments, locomotion mechanism 130 comprises one or more gears, gear trains, rotatable gears, and/or rack and pinions coupled together to enable rotational and/or translational movement of the bodies (e.g., medial body 110, lateral body 120) relative to each other. For example, in some embodiments, locomotion mechanism 130 comprises a rack and pinion configured on bottom portion 131b and a gear train configured on top portion 131b. In some embodiments, the rack and pinion provides translational movement, and gear train enables rotational movement. In some embodiments, the rack and pinion comprises a rack 132 and pinion 133, and the gear train comprises a rotatable gear 134 and pinion 135. In some embodiments, the gear train comprises a turn table or bearing 138 attached to top portion 131a of frame 131, which attaches to a rotating plate 139 fixed to rotatable gear 134. Each rack or gear is sized and shaped to provide at least one path, swing or degree of freedom of movement for the bodies relative to one another. In some embodiments, each rack or gear (e.g., rack 132, rotatable gear 134) may be straight, radiused, curved, curvilinear, round, parabolic, cammed surfaces or patterned, and any combinations thereof.

In some embodiments, locomotion mechanism 130 comprises one or more rails 136 attached to rack 132 that correspond to one or more carriages 137 attached to the bottom portion 131b of frame 131. The rails and carriages are configured to constrain the movement of locomotion mechanism (and attached bodies thereof) to only translational movement along rails 136. Referring now also to FIG. 2B, shown is a bottom perspective view of frame 131 of FIG. 2A showing one or more carriages attached to and extending down from bottom portion 131b configured to interface with and slide on rails 136.

Both the rack and pinion and gear train are coupled to and powered by at least one motor (e.g., motors 190, 192), enabling the actuation of the rack and pinion and/or gear train along their respective range or path (as shown by axis of rotation 102 and axis 104). In some embodiments, a first motor (e.g., motor 190) is connected to pinion 133 and is configured to actuate the rack and pinion, and a second motor (e.g., motor 192) is connected to the pinion 135 and is configured to actuate the gear train. In some embodiments, the motors of locomotion mechanism 130 (e.g., motors 190, 192) are electronically connected to a computing device (e.g., computer 600 discussed herein via for example motor driving circuitry), and further comprises any known sensor coupled to the motors and connected to the computing device configured for reading or capturing signals from the motors regarding position, speed, acceleration, etc. In some embodiments, such sensors may be built in to the motor.

In some embodiments, each of medial body 110 and lateral body 120 comprise one or more legs 150, a plurality of legs, a pair of legs, a set of legs, or leg units actuated from their respective bodies and/or positions on the bodies. In some embodiments, the pairs of legs, or leg units are configured, positioned or connected on various points, positions or regions on medial body 110 and/or lateral body 120. For example, in some embodiments, pairs of legs or leg units are positioned diametrically opposed on medial body 110 and/or lateral body 120. In some embodiments, a first pair of legs is positioned on first end 112 of medial body 110, and a second pair of legs is positioned on second end 114. In some embodiments, a third pair of legs is positioned on first end 122 of lateral body 120, and a fourth pair of legs is positioned on second end 124. In some embodiments, one or more pairs of legs may be positioned in the central portion 113 of medial body 110.

Referring now to FIG. 3A, shown is an exemplary actuator 140, one or more legs 150 and gear box 170 according to aspects of the present invention. In some embodiments, the one or more legs 150 comprise one or more drive mechanisms or actuators 140 for controlling and/or variably extending out each leg from their respective position on the bodies. In some embodiments, actuators 140 move each leg up and down along a vertical axis. In such embodiments, the term “extend” may be used to describe the leg moving downward toward the surface on which the device is walking, and the term “retract” may be used to describe the leg moving upward away from the surface. In some embodiments, actuators 140 are attached to positions on the bodies of system 100 (e.g., medial body 110 and/or lateral body 120) and retain and/or control the one or more legs 150. Each leg of one or more legs 150 is controlled or actuated by at least one actuator 140. In some embodiments, actuator 140 is coupled to and powered or driven by a gearbox 170. In some embodiments, rotational power from a differential 160 is passed through gear box 170 to power actuator 140 and to extend or retract legs 150. In some embodiments, each leg of one or more legs 150 comprises a timing belt, drive belt, rack and pinion, or the like, for enabling movement and control of the leg. In some embodiments, each actuator 140 is connected to a position on medial body 110 and/or lateral body 120. In some embodiments, each actuator 140 is coupled to and powered by one or more differential 160, one or more gear box 170, and/or at least one motor 180. In some embodiments, actuators 140 comprise one or more encoders (e.g., a rotary encoder, a linear encoder) or one or more position sensors for measuring any metric of actuator 140 and/or one or more legs 150 including leg position, leg speed, leg acceleration, leg slippage, belt 142 slippage, leg force, and any combinations thereof.

In some embodiments, each leg of one or more legs 150 comprises a first end 152 and a second end 154 and a length extending therebetween. In some embodiments, a timing or drive belt, or rack (for a rack and pinion) extends parallel along the length and attaches or terminates at each end. In some embodiments, each leg of the one or more legs 150 comprises at least one belt 142 (e.g., a timing belt, a toothed belt, a drive belt) extending between and fixedly attached to first end 152 and second end 154 of each leg. Belt 142 is driven by a pulley or gear 144 (e.g., a timing gear, pulley) rotatably attached to actuator 140. In some embodiments, actuator 140 and/or gear 144 is coupled to and/or powered by gear box 170, differential 160 and/or at least one motor 180.

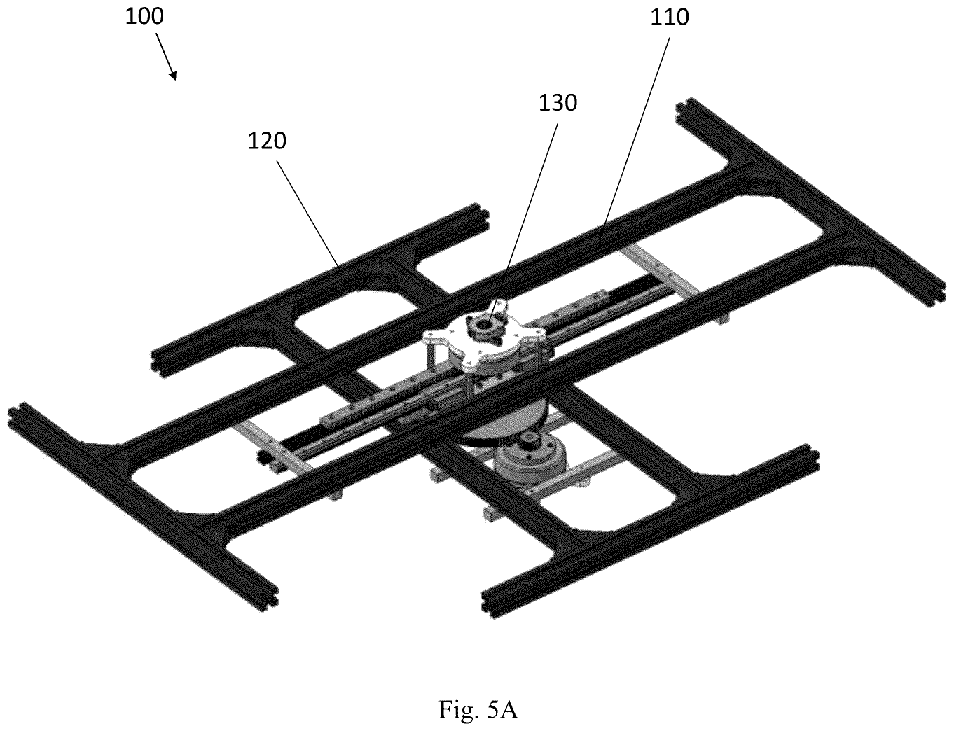

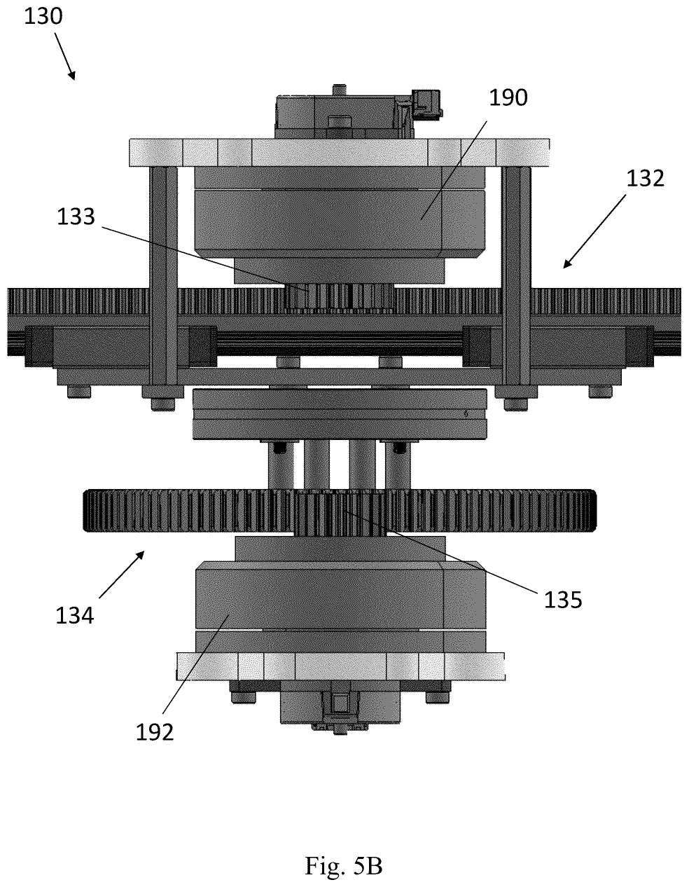

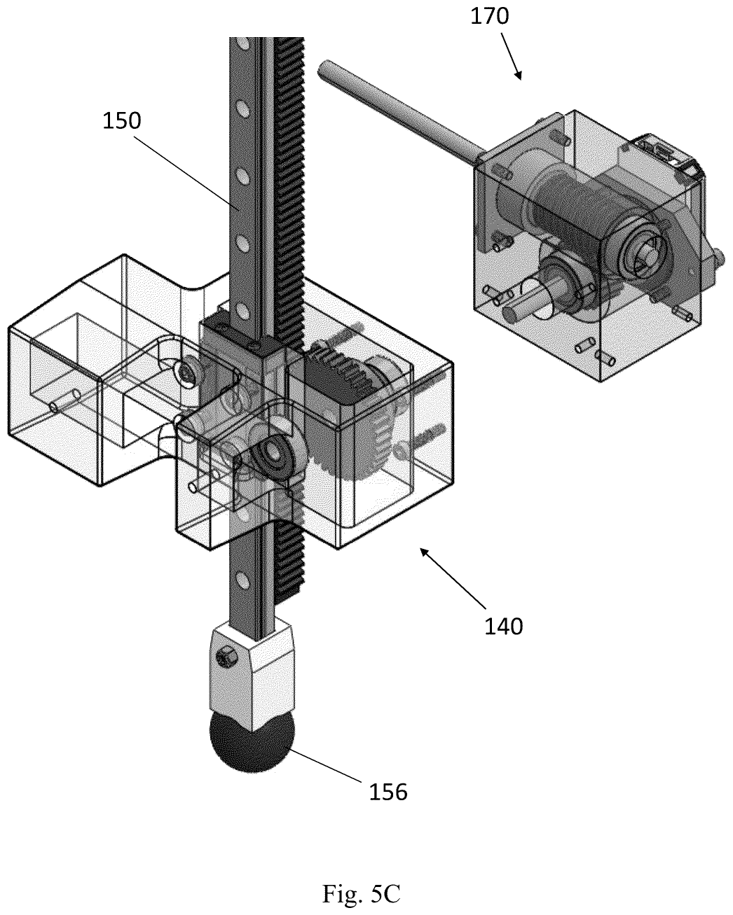

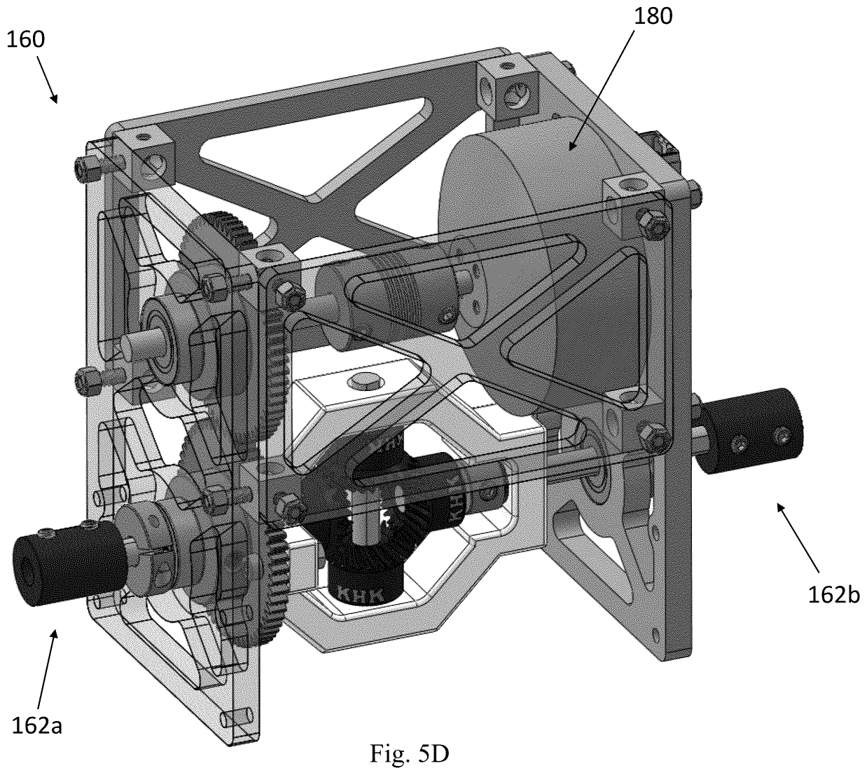

In some embodiments, actuator 140 comprises an idler pulley or gear 148 aligning and/or tensioning belt 142. In some embodiments, actuator 140 comprises one or more rollers 146 for slidably retaining one or more legs 150. In some embodiments, each leg of the one or more legs 150 comprises a foot 156 and cap 158 (see FIG. 1A). In some embodiments, foot 156 is round, compliant, and/or flexible, and configured to make contact with the ground or other surface. In some embodiments, the one or more legs 150 and actuators 140 comprise a rack and pinion mechanism (see FIG. 5C, left).

Referring now additionally to FIG. 3B, in some embodiments, pairs of legs or leg units comprise a first leg 150a and a second leg 150b. In some embodiments, each leg of the one or more legs 150 enables one or more degrees of freedom of movement, relative to one of medial body 110 or lateral body 120. Further, each leg in a pair of legs of the one or more legs 150, or the pair itself, may be constrained, unconstrained, and/or partially constrained to the other leg in the pair, or by another leg of another pair, or by another pair, enabling at least one additional degree of freedom of movement between the pair or outside the pair. Any possible combination of constrained individual legs or pairs of legs inside or outside the pairing for a system 100 with any number of legs are contemplated herein by the use of one or more differentials 160. For example, in some embodiments, each pair of legs comprises a first leg providing a first degree of freedom relative to the connected body (e.g., medial body 110, lateral body 120), a second leg providing a second degree of freedom relative to the connected body, and a differential 160 connecting the first and second legs providing a third degree of freedom of movement for the first and second legs relative to each other. In some embodiments, each leg of the pair of legs is configured to be at least partially actuated separately. In some embodiments, any degrees of freedom of movement of system 100 (e.g., movement of one or more legs 150, or medial body 110 and lateral body 120) may be rotational, translation, constrained, unconstrained, and/or partially constrained. FIG. 3C is a series of images depicting side views of exemplary pairs of legs (first leg 150a, second leg 150b) displaying the passive adaptability of the legs on uneven terrain as a result of the differential 160 connecting and differentially driving the pair.

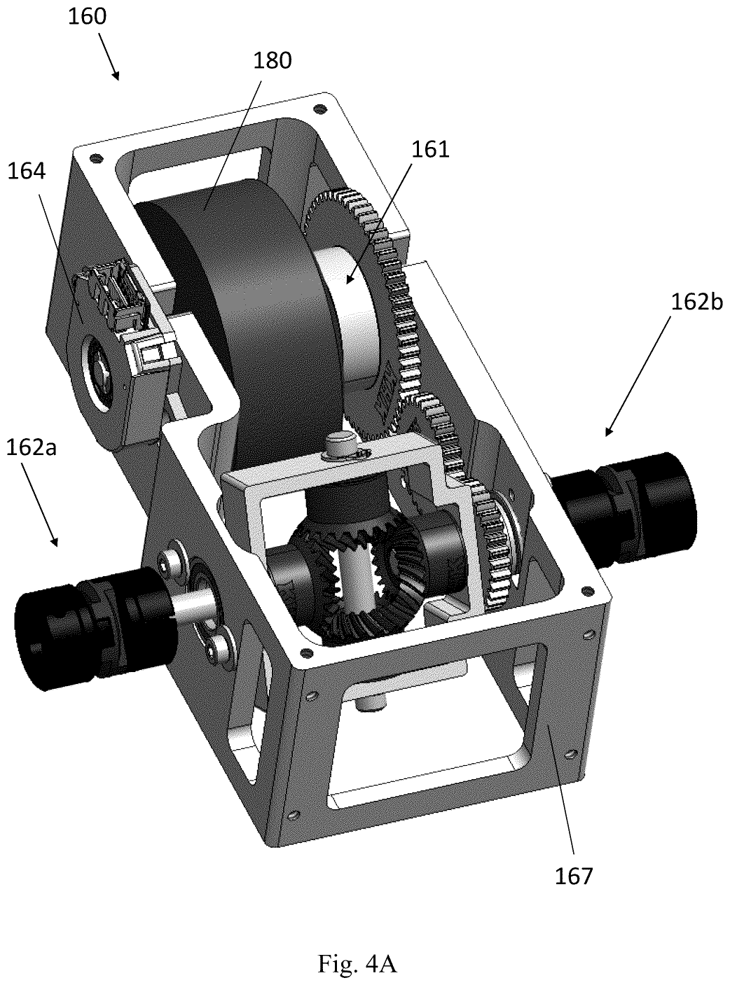

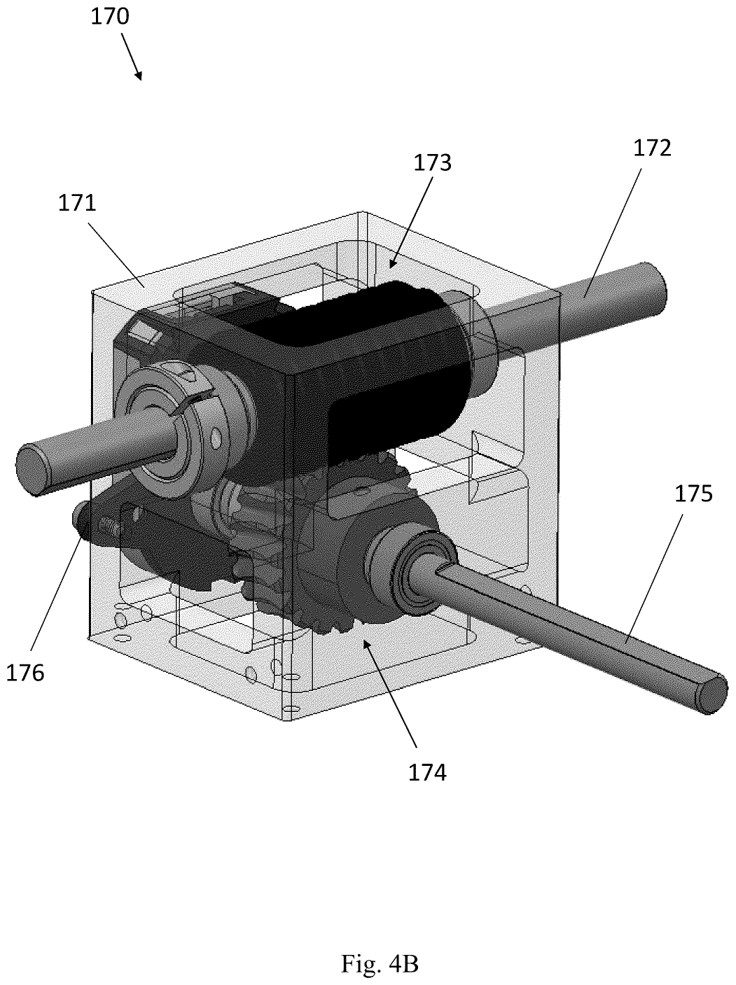

Referring now to FIG. 4A, shown is an exemplary differential 160 according to aspects of the present invention. In some embodiments, differential 160 comprises a housing or frame 167 at least partially enclosing and supporting the gears, shafts, motor(s), and components of differential 160. In some embodiments, differential 160 comprises an input shaft 161 coupled to at least one motor 180, and two output shafts (first output shaft 162a, second output shaft 162b). In some embodiments, at least one motor 180 provides rotational power to input shaft 161 of differential 160. In some embodiments, differential 160 comprises one or more encoders 164 (e.g., a rotary encoder, shaft encoder, angle encoder, optical encoder) comprising one or more sensors coupled to, or configured to measure the at least one motor 180 or any measurable metric or movement of differential 160. In some embodiments, one or more encoders 164 are connected to a computing device (e.g., computer 600) and configured for reading or capturing signals from the motors or differential regarding position, speed, acceleration, etc. In some embodiments, differential 160 comprises one or more actuators or controllers configured to selectively actuate differential locking or unlocking, or partial locking (i.e., limited slip configuration). In some embodiments, differential 160 is a limited slip differential (LSD), an electronically controlled LSD, a clutch type LSD, a torque vectoring differential, and any combination thereof.

Referring now to FIG. 4B, shown is an exemplary gear box 170 according to aspects of the present invention. In some embodiments, gear box 170 comprises a housing 171 containing and at least partially enclosing an input shaft 172 with a first gear 173 coupled to a second gear 174 with output shaft 175. In some embodiments, first gear 173 is a spiral or worm gear, and second gear 174 is a spur gear or wheel gear. In some embodiments, gearbox 170 further comprises one or more encoders 176 (e.g., a rotary encoder, shaft encoder, angle encoder, optical encoder) comprising one or more sensors configured to measure gear box 170 (e.g., the rotations of the gears, or the rotations of second gear 174 and output shaft 175). In some embodiments, each gearbox 170 comprises one or more actuators or controllers configured to selectively actuate the non-backdrivability of the gearbox, or change the rotation of the output shaft 175 of the gearbox.

Any arrangement of components (e.g., drive-trains, motors, mechanisms, gears, actuators) on the bodies of system 100 is contemplated herein. Each gear box 170 is powered by either at least one motor 180 and/or a differential 160. Similarly, each actuator 140 is driven via at least one differential 160, gearbox 170 and/or motor 180. For example, in some embodiments, each gearbox 170 comprises a worm gearbox, and/or is a non-backdrivable gearbox. In some embodiments, each actuator 140 is powered or driven by one or more gearboxes 170, which is connected to a differential 160 powered or driven by at least one motor 180. For example, in some embodiments, input shaft 172 of gearbox 170 is coupled to an output shaft (e.g., output shaft 162a, 162b) of differential 160, and also coupled to gear 144 of actuator 140. In some embodiments, actuator 140 and/or gearbox 170 directly connect to at least one motor 180. In some embodiments, one or more gearbox 170 connects first output shaft 162a of differential 160 with an actuator 140 of first leg (e.g., first leg 150a) of one or more legs 150, and one or more gearbox 170 connects second output shaft 162b of differential 160 with an actuator 140 and second leg (e.g., second leg 150b) of one or more legs 150, forming a leg unit, or a pair of legs.

Aspects of the present invention relate to combining and/or electronically connecting a computing device and system 100. In some embodiments, the computing device electronically connects to system 100 and/or the motors, mechanisms and/or sensors of system 100 and provides control of the motors and/or records telemetry or captures signals from the mechanisms, encoders and/or sensors. In some embodiments, system 100 comprises a computing device (e.g., device 600 discussed herein) electronically connected to any of the at least one motor 180, motor 190, motor 192, one or more encoders 164, one or more encoders 176, and/or any disclosed controller or actuator and is configured to actuate the motors and capture signals from the controllers, encoders and/or each sensor. In some embodiments, the one or more sensors comprise any of a position sensor, speed sensor, power sensor, torque sensor, rotation sensor, sensors 665 disclosed herein, and any combinations thereof. Further, system 100 may further comprise any number of sensors including any externally positioned cameras or sensors, inertial measurement units (IMUs), GPS or locational sensors, and any combinations thereof. For example, in some embodiments, system 100 comprises one externally mounted camera, and one or more internally mounted IMUs.

### Computing Device

In some aspects of the present invention, software executing the instructions provided herein may be stored on a non-transitory computer-readable medium, wherein the software performs some or all of the steps of the present invention when executed on a processor.

Aspects of the invention relate to algorithms executed in computer software. Though certain embodiments may be described as written in particular programming languages, or executed on particular operating systems or computing platforms, it is understood that the system and method of the present invention is not limited to any particular computing language, platform, or combination thereof. Software executing the algorithms described herein may be written in any programming language known in the art, compiled, or interpreted, including but not limited to C, C++, C#, Objective-C, Java, JavaScript, MATLAB, Python, PHP, Perl, Ruby, or Visual Basic. It is further understood that elements of the present invention may be executed on any acceptable computing platform, including but not limited to a server, a cloud instance, a workstation, a thin client, a mobile device, an embedded microcontroller, a television, or any other suitable computing device known in the art.

Parts of this invention are described as software running on a computing device. Though software described herein may be disclosed as operating on one particular computing device (e.g. a dedicated server or a workstation), it is understood in the art that software is intrinsically portable and that most software running on a dedicated server may also be run, for the purposes of the present invention, on any of a wide range of devices including desktop or mobile devices, laptops, tablets, smartphones, watches, wearable electronics or other wireless digital/cellular phones, televisions, cloud instances, embedded microcontrollers, thin client devices, or any other suitable computing device known in the art.

Similarly, parts of this invention are described as communicating over a variety of wireless or wired computer networks. For the purposes of this invention, the words “network”, “networked”, and “networking” are understood to encompass wired Ethernet, fiber optic connections, wireless connections including any of the various 802.11 standards, cellular WAN infrastructures such as 3G, 4G/LTE, or 5G networks, Bluetooth®, Bluetooth® Low Energy (BLE) or Zigbee® communication links, or any other method by which one electronic device is capable of communicating with another. In some embodiments, elements of the networked portion of the invention may be implemented over a Virtual Private Network (VPN).

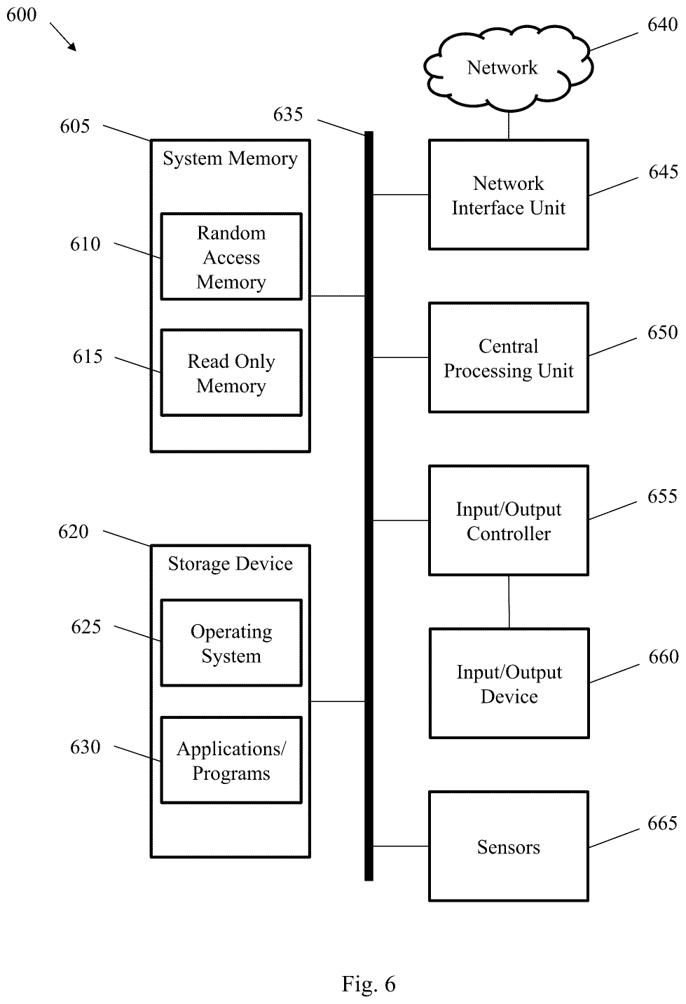

FIG. 6 and the following discussion are intended to provide a brief, general description of a suitable computing environment in which the invention may be implemented. While the invention is described above in the general context of program modules that execute in conjunction with an application program that runs on an operating system on a computer, those skilled in the art will recognize that the invention may also be implemented in combination with other program modules.

Generally, program modules include routines, programs, components, data structures, and other types of structures that perform particular tasks or implement particular abstract data types. Moreover, those skilled in the art will appreciate that the invention may be practiced with other computer system configurations, including hand-held devices, multiprocessor systems, microprocessor-based or programmable consumer electronics, minicomputers, mainframe computers, and the like. The invention may also be practiced in distributed computing environments where tasks are performed by remote processing devices that are linked through a communications network. In a distributed computing environment, program modules may be located in both local and remote memory storage devices.

FIG. 6 depicts an illustrative computer architecture for a computer 600 for practicing the various embodiments of the invention. The computer architecture shown in FIG. 6 illustrates a conventional personal computer, including a central processing unit 650 (“CPU”), a system memory 605, including a random access memory 610 (“RAM”) and a read-only memory (“ROM”) 615, and a system bus 635 that couples the system memory 605 to the CPU 650. A basic input/output system containing the basic routines that help to transfer information between elements within the computer, such as during startup, is stored in the ROM 615. The computer 600 further includes a storage device 620 for storing an operating system 625, application/program 630, and data.

The storage device 620 is connected to the CPU 650 through a storage controller (not shown) connected to the bus 635. The storage device 620 and its associated computer-readable media provide non-volatile storage for the computer 600. Although the description of computer-readable media contained herein refers to a storage device, such as a hard disk or CD-ROM drive, it should be appreciated by those skilled in the art that computer-readable media can be any available media that can be accessed by the computer 600.

By way of example, and not to be limiting, computer-readable media may comprise computer storage media. Computer storage media includes volatile and non-volatile, removable and non-removable media implemented in any method or technology for storage of information such as computer-readable instructions, data structures, program modules or other data. Computer storage media includes, but is not limited to, RAM, ROM, EPROM, EEPROM, flash memory or other solid state memory technology, CD-ROM, DVD, or other optical storage, magnetic cassettes, magnetic tape, magnetic disk storage or other magnetic storage devices, or any other medium which can be used to store the desired information and which can be accessed by the computer.

According to various embodiments of the invention, the computer 600 may operate in a networked environment using logical connections to remote computers through a network 640, such as TCP/IP network such as the Internet or an intranet. The computer 600 may connect to the network 640 through a network interface unit 645 connected to the bus 635. It should be appreciated that the network interface unit 645 may also be utilized to connect to other types of networks and remote computer systems.

The computer 600 may also include an input/output controller 655 for receiving and processing input from a number of input/output devices 660, including a keyboard, a mouse, a touchscreen, a camera, a microphone, a controller, a joystick, or other type of input device. Similarly, the input/output controller 655 may provide output to a display screen, a printer, a speaker, or other type of output device. The computer 600 can connect to the input/output device 660 via a wired connection including, but not limited to, fiber optic, Ethernet, or copper wire or wireless means including, but not limited to, Wi-Fi, Bluetooth, Near-Field Communication (NFC), infrared, or other suitable wired or wireless connections.

As mentioned briefly above, a number of program modules and data files may be stored in the storage device 620 and/or RAM 610 of the computer 600, including an operating system 625 suitable for controlling the operation of a networked computer. The storage device 620 and RAM 610 may also store one or more applications/programs 630. In particular, the storage device 620 and RAM 610 may store an application/program 630 for providing a variety of functionalities to a user. For instance, the application/program 630 may comprise many types of programs such as a word processing application, a spreadsheet application, a desktop publishing application, a database application, a gaming application, internet browsing application, electronic mail application, messaging application, and the like. According to an embodiment of the present invention, the application/program 630 comprises a multiple functionality software application for providing word processing functionality, slide presentation functionality, spreadsheet functionality, database functionality and the like.

The computer 600 in some embodiments can include a variety of sensors 665 for monitoring the environment surrounding and the environment internal to the computer 600. These sensors 665 can include a Global Positioning System (GPS) sensor, a photosensitive sensor, a gyroscope, a magnetometer, thermometer, a proximity sensor, an accelerometer, a microphone, biometric sensor, barometer, humidity sensor, radiation sensor, or any other suitable sensor.

Aspects of the invention relate to machine learning executed on a computing device, wherein the computing device may be computer 600. Machine learning is a type of artificial intelligence (AI) that provides systems the ability to learn and improve from experience without being explicitly programmed. Machine learning utilizes algorithms to analyze data sets and identify correlations and patterns, and then uses those patterns to make predictions and decisions. In general, machine learning models fall into three primary categories: supervised machine learning, unsupervised machine learning and semi-supervised machine learning.

Supervised learning, is defined by its use of labeled datasets to train algorithms to classify data or predict outcomes accurately. As input data is fed into the model, the model adjusts its weights until it has been fitted appropriately. Some methods used in supervised learning include neural networks, naïve bayes, linear regression, logistic regression, random forest, and support vector machine (SVM).

Unsupervised learning, uses machine learning algorithms to analyze and cluster unlabeled datasets. These algorithms discover hidden patterns or data groupings without the need for human intervention. Principal component analysis (PCA) and singular value decomposition (SVD) are two common approaches for this. Other algorithms used in unsupervised learning include neural networks, k-means clustering, and probabilistic clustering methods.

Semi-supervised learning offers a medium ground between supervised and unsupervised learning. During training, semi-supervised learning uses a smaller labeled data set to guide classification and feature extraction from a larger, unlabeled data set.

Classification is a part of supervised learning (learning with labeled data) through which data inputs can be easily separated into categories. In machine learning, there can be binary classifiers with only two outcomes (e.g., spam, non-spam) or multi-class classifiers (e.g., types of books, animal species, etc.). A popular classification algorithm is a decision tree whereby repeated questions leading to precise classifications can build an “if-then” framework for narrowing down the pool of possibilities over time.

Clustering is a form of unsupervised learning (learning with unlabeled data) that involves grouping data points according to features and attributes. The most common kind of clustering is K-means clustering, which involves representing each cluster by a variable “k” and then defining the centroid of those clusters.

Regression is a type of structured machine learning algorithm where we can label the inputs and outputs. Linear regression provides outputs with continuous variables (any value within a range), such as pricing data. Logistical regression is when variables are categorically dependent and the labeled variables are precisely defined. For example, you can classify whether a store is open as (1) or (0), but there are only two possibilities.

Deep learning is an application of machine learning that imitates the workings of the human brain. Deep learning networks interpret big data, both unstructured and structured, and recognize patterns. Neural networks are closely related to deep learning, they create sequential layers of neurons that deepen the understanding of data collected from a machine to provide an accurate analysis. A neural network consists of layers of nodes, having neurons, which receive stimulation from “trigger” data. This data then is assigned a weight through coefficients, as some data inputs may be more significant than others. Neurons normally come in three different layers: an input layer of data, a hidden layer with mathematical computations, and an output layer.

### EXPERIMENTAL EXAMPLES

The invention is further described in detail by reference to the following experimental examples. These examples are provided for purposes of illustration only, and are not intended to be limiting unless otherwise specified. Thus, the invention should in no way be construed as being limited to the following examples, but rather, should be construed to encompass any and all variations which become evident as a result of the teaching provided herein.

Without further description, it is believed that one of ordinary skill in the art can, using the preceding description and the following illustrative examples, make and utilize the present invention and practice the claimed methods. The following working examples therefore are not to be construed as limiting in any way the remainder of the disclosure.

### Example 1: Passively Adaptive Legged Robot with Gear Differentials and Non-Backdrivable Prismatic Legs

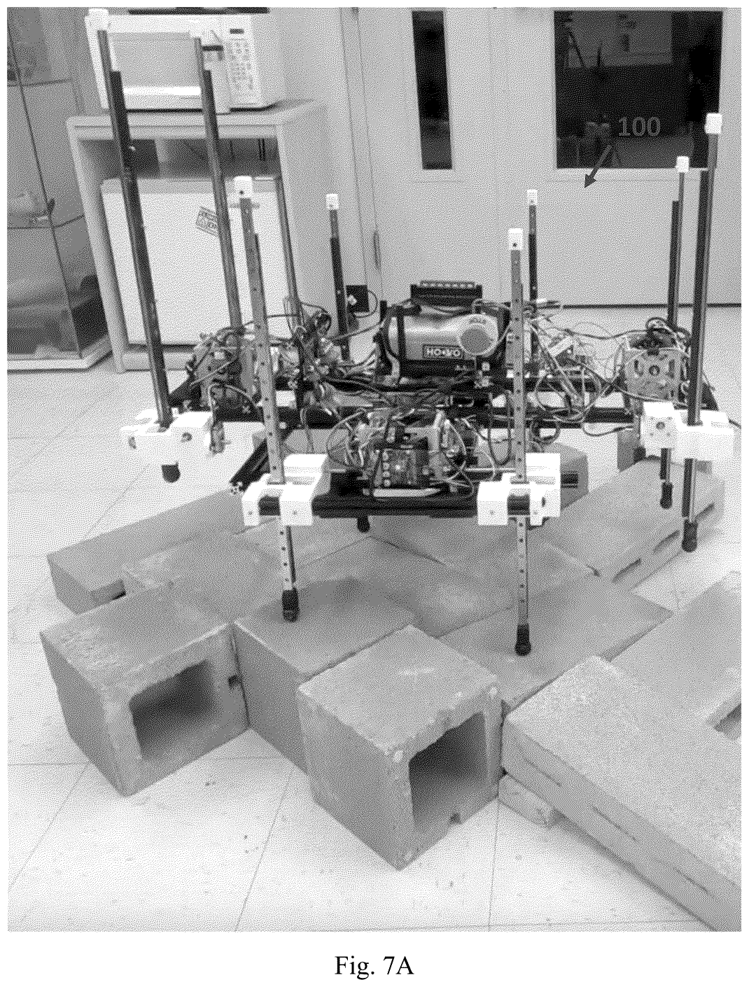

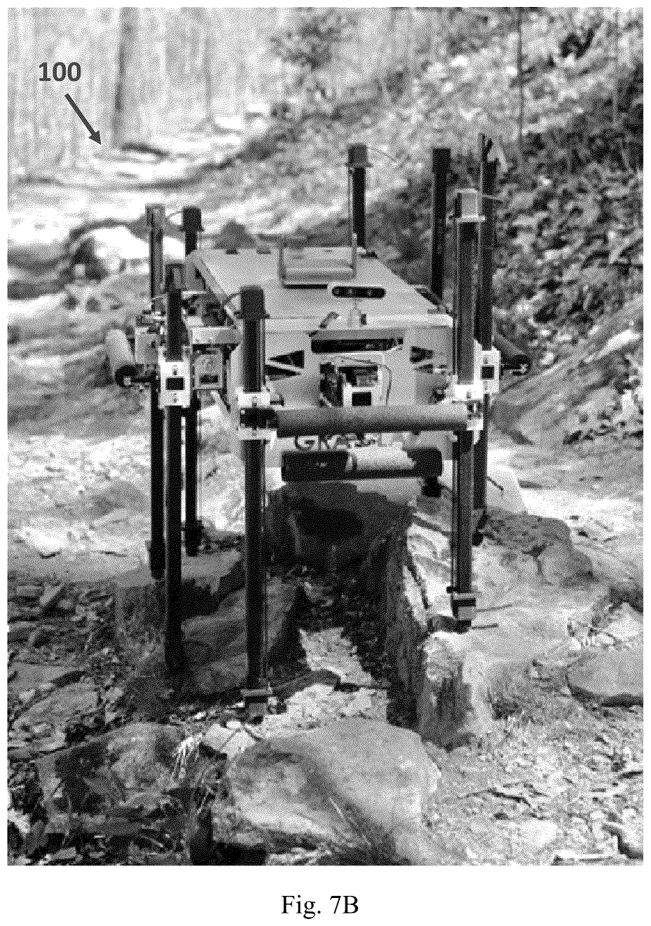

The disclosed legged robot (an exemplary prototype legged robot is shown in FIG. 7A) differs from existing legged robots in that the legs have single degree-of-freedom (DoF) prismatic joints in a vertical configuration. Since the legs do not have any additional degrees of freedom, locomotion is achieved through a relative motion between two body frames that each has a set of four prismatic legs. The two body frames differ from a flexible spine or a compliant body frame in that the degrees of freedom between them are discrete and controllable. This type of robotic legged locomotion has been referred to as twin-frame locomotion or an alternating gait.

The legged robot is an octopod comprising two body frames (as shown in FIG. 1A) that each comprise two pairs of prismatic legs (see FIG. 3B). The upper or medial body comprises a pair at the front and the rear and the lower or lateral body at the right and the left. A motor actuates each pair of prismatic legs through a gear differential (see FIG. 5C, left) that divides the motor torque to the legs and allows them to move independently. The unconstrained degree of freedom in the gear differential makes the prismatic leg pair an underactuated mechanism and thus passively adaptive to terrain height differences.

This arrangement of the underactuated leg pairs around the robot body enables a novel method of body roll and pitch motions. With spherical feet that facilitate rolling contacts on the ground, the legged robot can roll by actuating the front and rear leg motors and pitch by actuating the right and left leg motors. Although one motor with two more differentials could actuate four legs, such configuration would not have the ability to control the body's tilt by moving the opposing legs. Combined with the forward translation and yaw motors in the locomotion mechanism, the robot uses a total of six motors to move the body in 3D space.

Another novel feature of the robot's mechanical design is the use of worm gears (as shown in FIG. 5C, right) to incorporate their non-backdrivability. The non-backdrivability ensures that the underactuated legs do not reconfigure and tilt the body as the robot shifts its weight during locomotion. It also allows the robot to significantly save power and stand indefinitely in stance since the motors do not have to actively support the weight of the robot. While other works have also incorporated mechanisms to constrain and stabilize underactuated mechanisms, this design is the first to apply both underactuation and non-backdrivability to legged locomotion to the best of the authors' knowledge.

The prismatic leg design comprises a 10:1 worm gearbox that actuates a vertical linear rail via a rack and pinion. The worm gearbox amplifies the motor torque and introduces the non-backdrivable behavior to the leg. Non-backdrivability or low actuation transparency imposed by the transmission is undesirable in highly dynamic legged locomotion that requires high contact forces and impulse. Not only are the gears more susceptible to damage, but it also inhibits proprioceptive sensing of contact forces, a critical requirement in these robots' control strategies. In contrast, the disclosed legged robot adopts a statically stable locomotion that minimizes the ground reaction force and contact impulse.

Theoretically, a worm gear is non-backdrivable if the coefficient of friction between the worm and the worm wheel exceeds the tangent of the worm's lead angle.

$$tan ( θ ) < μ \qquad Equation 1$$

The coefficient of friction is difficult to precisely characterize and is dependent on several factors including lubrication, gear teeth wear, and sliding velocity at the teeth. Moreover, the non-backdriving condition is typically stated only for static conditions since the coefficient of friction drops off nonlinearly with increasing velocity. On the other hand, a worm's lead angle is defined by the specification and tends to decrease with increasing gear ratio, which follows with the trend that a higher gear ratio transmission is more difficult to backdrive.

The coefficient of friction of the worm drive at rest was estimated by taking an empirical value of 0.145 for a carbon steel worm and a bronze worm wheel. Taking the tangent of the worm's lead angle, 7°11′, it was shown that the friction coefficient is higher and that the worm drive should not be backdrivable. It is important to remember that this is for a static scenario, which is not fully representative of the prismatic legs during the entire locomotion, and the true coefficient of friction may be lower and vary over the operation of the legs. While it is possible to use a worm with a lower lead angle and a higher gear ratio to better ensure non-backdrivability, the increase in size and mass of the worm drives across all eight legs and the resulting reduction in leg speed were inhibiting factors in this design choice.

The gear differential transmits and evenly divides the motor torque to the prismatic leg pair. As opposed to the ring and pinion gears used in automotive transmissions, a 1:1 spur gear train between the motor and the differential carrier imposes a lower motor speed requirement. The differential carrier contains four spiral miter gears-two output gears and two side gears that contribute to the additional degree of freedom in the prismatic leg pair. Each gear differential is actuated by a brushless motor with a peak torque of 1.25 Nm and no-load speed of 9900 RPM.

The 2-DoF locomotion mechanism (as shown in FIG. 5B) sits vertically between the two body frames to facilitate relative motion for propulsion. Because the robot can roll and pitch by actuating the prismatic legs, the locomotion mechanism only needs the rotational and translational degrees of freedom. With these two degrees of freedom, the robot can reach all points in the plane of the robot body through a sequence of steps.

The upper body holds a linear rail and a gear rack along its length. The translation motor rides on the rail's two carriages and engages the gear rack to provide the translational motion. The carriages attach to the inner race of the yaw bearing underneath the linear rail, and the outer race of the yaw bearing mounts to the lower body, which joins the two bodies and creates the rotational degree of freedom. The yaw motor sits on one side of the lower body and actuates the spur gear fixed to the inner race of the yaw bearing, which then turns the upper body relative to the lower body.

The robot utilizes a Teensy 4.1 microcontroller board with an ARM Cortex-M7 processor for locomotion including the gait cycle state machine, corrective maneuvers based on proprioceptive sensing, and data logging. The Teensy sends motor commands to and receives motor position and torque information from six ODrive Pro motor controller boards over CAN. It also logs the eight prismatic legs' position measured by AMT102-V encoders, the system current draw measured by an ACS711 board and robot body pose estimation reported by a 9-axis BNO085 IMU board. Two 5,000 mAh 6S lithium-polymer batteries configured in parallel provide power for the system.

The underactuated, non-backdrivable prismatic legs enable passively adaptability to rough terrain and result in a unique and simplified control strategy and gait. During touchdown, the motor switches to torque control and provides just enough torque to lower the legs. Because a gear differential actuates each pair of prismatic legs, the two legs can independently contact the ground and stop regardless of the terrain height differences. This can be accomplished without sensing the terrain thanks to the underactuation and the minimal ground reaction force. The passively adaptive prismatic legs combined with this control strategy also reduces the disturbance on the body since the contact forces are minimal. By switching to position control after ground contact, the robot leverages the worm gear's non-backdrivability to maintain the leg configurations for stability while the other body moves forward.

The non-backdrivability of the legs and the decoupled motions also completely change the power characteristics of the legged robot. During locomotion, the forward translation does not use much power since the robot maintains a level posture. The leg motors also draw little power during swing and stance phases, only reaching peak power when raising or lowering the body.

The disclosed example presents a design of a novel legged robot that can maneuver rough terrains using passively adaptive prismatic legs. A unique combination of underactuation and non-backdrivability allows for reduced actuation and simplified control without compromising stability. The non-backdrivability also greatly reduces the overall power consumption, resulting in an extended continuous runtime. Although the robot is not highly dynamic like many of the existing legged robots, its locomotion approach has several advantages such as minimal dependence on sensing and computation, passive adaptability to rough terrains, and relatively low power consumption. The prismatic legs also have the potential to negotiate unstructured environments better since a linear leg will not collide with the environment due to an elbow-up or elbow-down configuration.

### Example 2: Passive Adaptability to Rough Terrain Via Mechanically Intelligent Legged Design

High dimensional configurations of many legged robots require high actuator count, control complexity, and sensing requirements that limit a more widespread deployment. Disclosed herein is a legged robot capable of robust locomotion over various rough terrains using mechanically intelligent legs. Underactuation of its vertical prismatic legs using gear differentials equips the robot with passive adaptability to unknown terrains, allowing it to stay mostly level despite large differences in terrain heights. The legs of the robot can passively come to rest on any surface contour using open-loop control with minimal disturbance forces, enabled by a differential mechanism between leg pairs. By separating the task of terrain adaptation and propulsion through task-oriented design, the disclosed robot can achieve stable locomotion with only six actuators and minimal sensing and control parameters, further simplifying control and planning problems. Further discussed herein are the unique actuation strategies and motion primitives enabled by the legged robot design demonstrating their advantages through experimental results.

An alternative approach to robotic legged locomotion is presented in this example that places emphasis on the task specification of locomotion. Locomotion is a task with six degrees of freedom since it is one where a body of mass is moved from one configuration to another in the special Euclidean group SE. Naturally, the task is subject to the constraints of the dynamics, contacts and stability over terrain. However, the task specification does not imply anything about the required physical system. Indeed, animals of different species and sizes adopt different postures, leg configurations, and gaits. Similarly, one must consider all available engineering solutions in synthesizing an artificial system for legged locomotion.

The mechanically intelligent legs for the robot disclosed herein embody the passive adaptability of biological legged systems and realize this property in a legged robot through kinematic underactuation often utilized in the design of adaptive or compliant robot hands. The main properties of underactuated mechanisms are that all joints or degrees of freedom in the system are driven by a fewer number of actuators and that there exists at least one internal degree of freedom such that the system can reconfigure without displacing any actuator. From this definition, systems such as a double pendulum with a motor at only one joint or a mechanism with one motor but fixed coupling among the joints are not considered kinematically underactuated. A common application of kinematically underactuated mechanisms, referred to as underactuated mechanisms herein, is an adaptive robot hand whose finger links can conform to the object geometry and size upon contact and form an enveloping grasp.

Disclosed herein is a legged robot (in some examples referred to as “Thumper” or “Thumpr”), a full-mobility octopod robot that achieves rough terrain locomotion with simple control strategies and proprioceptive sensing. By reformulating the problem of legged locomotion to one in which the task is mostly decoupled from the constraints, a legged robot was designed that accomplishes terrain adaptation and propulsion separately. The disclosed legged robot features two distinct body frames that can move relative to each other with a translational and rotational degree of freedom and eight vertical prismatic legs that can passively adapt to unknown rough terrains. The disclosed approach to legged locomotion offers several advantages over existing solutions. By using underactuated mechanisms for passively adaptive legs, the robot uses far fewer actuators than other multi-legged robots. Despite the reduced degrees of actuation, the robot's four-leg stance maintains static stability and resists reconfiguration during actuation due to the non-backdrivability of worm gears driving the prismatic legs.

Evaluation of Thumpr's locomotion capabilities took place in several natural and artificial environments including an obstacle course of concrete blocks, a grass hill, a hiking trail, a wooded area covered with soft dirt, and a thick layer of leaves, among others. Thumpr successfully negotiated a wide range of contact conditions from a rigid yet extremely discontinuous terrain to a compliant, sloped terrain. The results indicate that the mechanically intelligent legs can translate well across different rough terrain conditions, significantly reduce the control and planning efforts, and enable robots to operate for extended periods and in previously unaddressed settings. The disclosed experimental results demonstrate the effectiveness of the robot.

Rough terrain locomotion reimagined. Legged robots in the literature necessitate numerous actuators, complex control schemes, and extensive sensing for locomotion in unstructured environments such as those shown here. FIGS. 7A & 7B depict exemplary legged robots that achieves robust locomotion over these rough terrains by using mechanically intelligent legs. Thumper negotiates various natural and artificial uneven terrains using the passive adaptability in its legs. Thumper has eight vertical, prismatic legs that move up and down during touchdown and swing phases. Each pair of prismatic legs is coupled differentially through a gear differential that enables one leg to passively touch down to a different terrain height after the first leg makes contact (see FIG. 3C). Translational and rotational degrees of freedom move one set of four legs relative to the other set of four, enabling locomotion.

Design and passive adaptability of mechanically intelligent legs. FIG. 1A depicts an exemplary arrangement of mechanically intelligent leg units in Thumpr: Front and rear leg units form the medial body that can pitch, and right and left leg units form the lateral body that can roll the robot body during stance phase. FIG. 3B is a rendering of exemplary mechanically intelligent legs and transmission of the disclosed robot. A gear differential allows one electric motor to drive two prismatic legs while equipping them with passive adaptability to rough terrains through contact. A worm drive makes each prismatic leg non-backdrivable, resisting reconfiguration of the legs due to underactuation. FIG. 3C is an illustration of a ground contact sequence by the mechanically intelligent leg unit. In the left image, the motor begins actuating the gear differential whose two outputs drive their respective prismatic leg. In the center image, the left prismatic leg contacts the terrain and begins applying a force on the ground while the right prismatic leg continues moving downward. In the right image, the right prismatic leg also contacts the ground, completing the touchdown phase.

Mechanically intelligent legs: Each unit of the mechanically intelligent legs has one electric motor, two vertical prismatic legs and a gear differential situated between the motor and the legs to enable passive adaptability. Rotational motion is converted to linear motion of the leg with a drive, toothed or timing belt pulley that drives an open drive, toothed, or timing belt clamped to both ends of the leg. During the ground contact phase, the leg motor drives the gear differential whose two outputs move the two vertical prismatic legs downward to the ground. Because a gear differential divides its input torque into halves and has an internal degree of freedom, the two prismatic legs can make contact at different times and at different foothold heights. When one leg makes contact first, the other leg continues moving downward due to underactuation. To minimize body perturbation caused by asynchronous ground contact, the actuation torque is chosen empirically. In locomotion tests across different indoor and outdoor environments, a velocity-limited torque setpoint of 0.16 Nm for the leg motors demonstrated a reasonable balance between leg touchdown speed and minimal body disturbance.

In some embodiments, the disclosed legged robot has four pairs of legs-two on the medial body frame with each on the front and back and two on the lateral body frame with each on the right and left. The prismatic joints are placed at the four corners of the bodies (i.e., the medial and lateral body frames) and are oriented perpendicularly to the body plane. This arrangement of the leg pairs around the robot body and the degree of underactuation form a balanced compromise between control authority and simple actuation. With spherical feet that facilitate rolling contacts, the legged robot controls its body roll by actuating the front and rear legs in stance and its body pitch by actuating the right and left legs in stance. Furthermore, the chosen design configuration uses half the number of actuators for the legs compared to one that has fully actuated legs-four fewer motors in this case. It should be noted that while the kinematics of the stance legs and spherical feet do permit body roll and pitch motions, controlling the roll and pitch poses another problem in the presence of unconstrained internal degrees of freedom.

The property of passive adaptability in the mechanically intelligent legs depends on several design variables including the tension in the timing belt and the friction in the bevel gears of the gear differential. Achieving the designed torque transmission capacity requires sufficient tension and belt wrap angle so that the belt teeth do not skip. However, increasing the belt tension increases the required drive torque and negatively affects the passive adaptability of the legs since a higher leg force would cause greater body perturbation upon contact. Instead of increasing the tension, belt skipping is physically prevented with idler rollers that enclose the belt around the pulley and prevent the belt from bending radially outward. This eliminates skipping without higher tension but increases belt slack on one side during loading. The slack side of the belt has not proven to be detrimental in any aspect to the operation or functionality of the mechanically intelligent legs. Proper backlash and lubrication of the bevel gears in the gear differential also improves passive adaptability by reducing the overall resistance to the rotation of the spider gears.

The disclosed legged robot mitigates the lack of control authority in body roll during one stance phase, i.e. the period during which the legs of the medial or lateral body stand on the ground, and in body pitch during the other stance phase by leveraging non-backdrivable worm gears in the leg transmission. In some embodiments, each gear differential's output shafts drive a worm gearbox with a 1.25 module and a 10:1 gear ratio. In some embodiments, the worm drive comprises a carbon steel worm and bronze worm wheel that exhibits no discernible backdriving while holding the weight of a 23 kg robot during locomotion or long periods of idling. The worm gearbox drives the timing belt pulley of the prismatic leg. Connecting the outputs of an underactuated mechanism to non-backdrivable mechanisms such as a worm gear retains the passive adaptability of the underactuated mechanism but also prevents any reconfiguration of the said mechanism without actuation. This addition to the leg transmission ensures that the stance legs do not reconfigure without actuation and tilt the body despite unequal forces acting between the two legs due to the center of mass location. Without the worm gears, the legged robot would need to take much shorter steps such that the motion of the center of mass via translation does not reconfigure the underactuated legs and cause tip-over.

However, it is important to distinguish the differential motion of the legs with and without actuation and understand that the non-backdrivability only prevents differential motion without actuation. A simple force balance equation of the two legs shows that the net force acting along the prismatic joint direction is not equal for the two legs in most robot configurations since the gear differential always distributes half of the input torque to the two outputs, but the forces on the prismatic joints due to the robot weight varies depending on the position of the footholds relative to the robot's center of mass. Therefore, stable control of body height or tilt requires being in configurations that do not suffer from unbalanced forces in the vertical prismatic joints that will induce undesired motions since non-backdrivability cannot be utilized to keep the robot stable.

Passive adaptability evaluation: passive adaptability of the four mechanically intelligent leg units in the legged robot was tested independently to assess their capabilities and to determine suitable actuation parameters for rough terrain locomotion. First, ground contact over uneven terrain was tested to verify that the unconstrained degree of freedom in the gear differential permitted the two underactuated prismatic legs to freely move to different joint positions. Each unit was placed above an uneven terrain setup where one leg would contact a flat floor and another leg would contact an obstacle block. Then, a velocity-limited constant torque command was sent to the leg motor to drive the legs towards the ground. When ground contact was detected for both legs, the motor torque command was set to zero to stop applying forces to the ground. In this test, it was observed that the leg above the obstacle block contacted the ground first and slowed to a stop while the other leg decelerated briefly before continuing its downward motion until contact. The sustained ground reaction force from the first leg contact did not perturb the body more than a small structural deflection in the body frame.

The same procedure was performed for taller obstacles under one leg to determine the appropriate motor torque value to use in the simple open-loop torque controller for the legs during the touchdown phase of the gait cycle. Desired objectives of the open-loop torque controller for the leg motors include sufficient actuation torque to guarantee ground contact with both legs and minimization of body perturbation due to high ground reaction forces. The overall friction and inertia in the leg transmission increase when the two prismatic legs travel at different speeds because the spider gears in the gear differential rotate to allow the two output gears to rotate at different speeds. This increase in load requires the leg motor torque to be greater during rough terrain locomotion. Conversely, a high leg motor torque creates high impulse ground contacts that jerk the body up. Ground contact testing over several obstacle sizes showed that a motor torque command of 0.16 Nm resulted in successful, passively adaptive ground contacts even for a large terrain height difference between the two contacts with minimal effect on the body orientation.

Over the course of multiple stance phases, each leg unit may encounter largely varying terrain unevenness such that one leg extends much longer than the other in one stance phase and the opposite occurs in the next stance phase. The configuration of the legs on a rough terrain in one stance phase must not affect their passive adaptability in the next phase. Therefore, passive adaptability to a varying rough terrain was evaluated by executing consecutive leg touchdowns and moving an obstacle block on the ground back and forth between the two legs. After each stance phase, the motor retracted the legs only enough to clear the obstacle block, so one leg was fully retracted while the other leg was still partially extended. In the following touchdown phase, the partially extended leg made contact first while the other leg took longer to touch down. This test verified that the passive adaptability enabled by the gear differential did not depend on previous leg configurations.

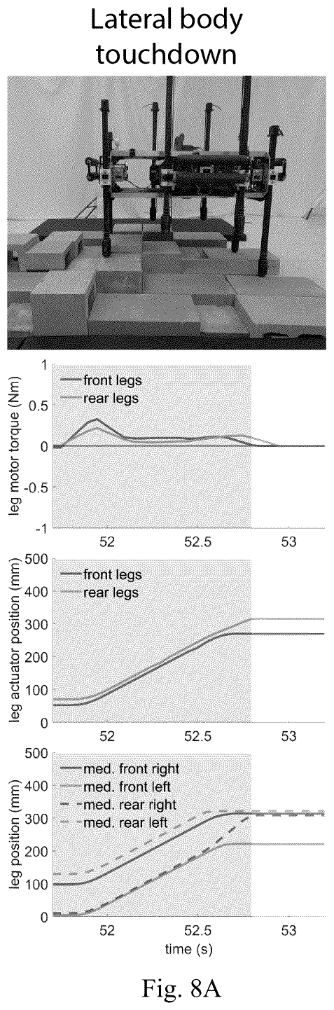

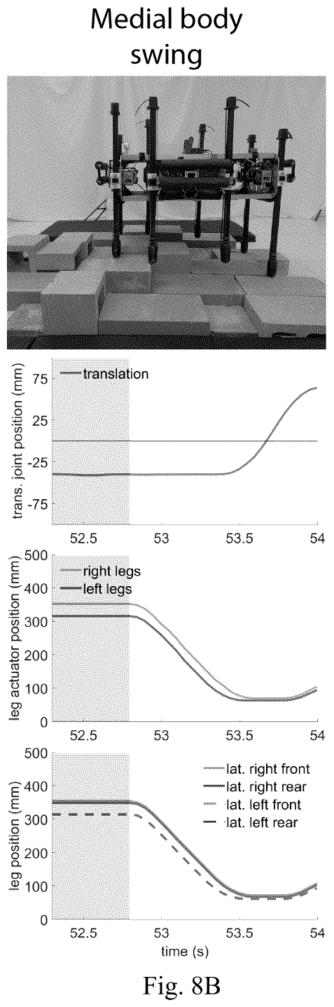

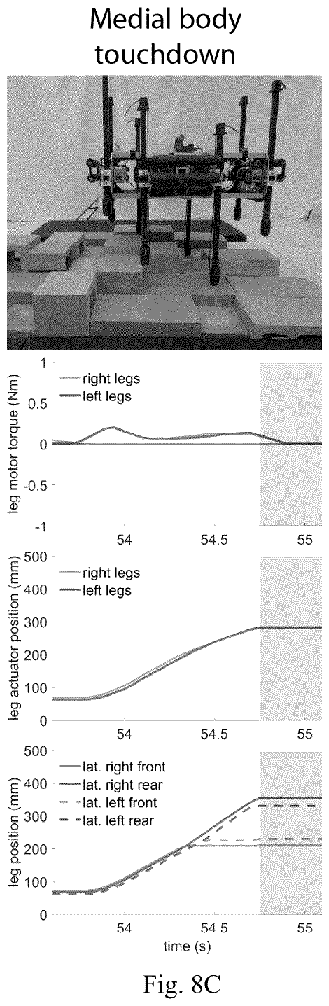

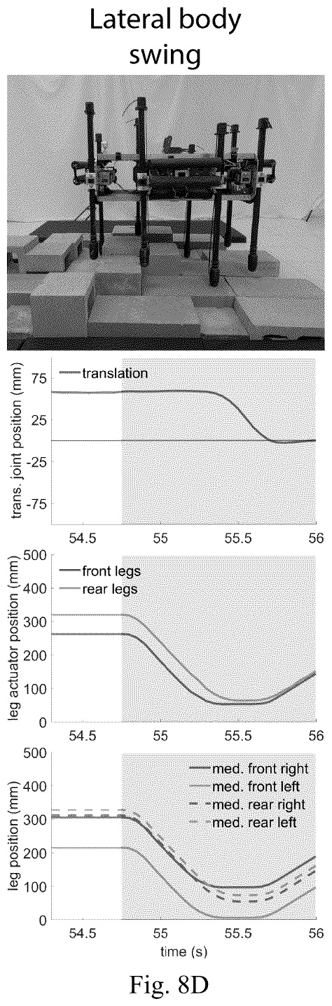

FIGS. 8A-8D are images depicting motor and joint trajectories during gait phases of the disclosed legged robot. Shaded regions indicate lateral body swing phase, and unshaded regions indicate medial body swing phase. FIG. 8A depicts how open-loop torque control of the leg motors on the medial body drives the swing legs downward until they contact the terrain at different heights. The leg motor ramps up its torque during startup and then maintains a lower torque for the remainder of touchdown. FIG. 8B depicts how the translation motor slides the lateral body forward as its swing legs retract. FIG. 8C depicts how the lateral body now uses the same leg control strategy for its touchdown phase. FIG. 8D depicts how the translational joint travels in the other direction for the swing phase of the medial body.

After individual mechanically intelligent leg units were tested and their actuation parameters were determined, an alternating gait was designed to assess the effectiveness of the legs' passive adaptability in a series of locomotion tests over an indoor obstacle course made from concrete blocks of various sizes. FIGS. 8A-8D show the relevant joint position and motor torque trajectories during each of the four gait phases from left to right-lateral body touchdown, medial body swing, medial body touchdown, lateral body swing. The touchdown and swing phases for the two bodies exhibit similar trajectory profiles. The leg motors accelerated the prismatic legs downward with an initial torque of 0.32 Nm followed by 0.16 Nm to continue driving all legs to the ground. The bottom plot of each figure shows the two legs in each mechanically intelligent leg unit touching down to different strokes. During the lateral body touchdown phase, the two medial rear legs start at positions differing by over 120 mm due to a partial leg retraction after their last stance phase over uneven terrain. The passive adaptability in the gear differential, however, permits the two legs to contact the ground at similar leg strokes. On the contrary, the two lateral right legs start at nearly identical strokes and extend to strokes differing by almost 150 mm.

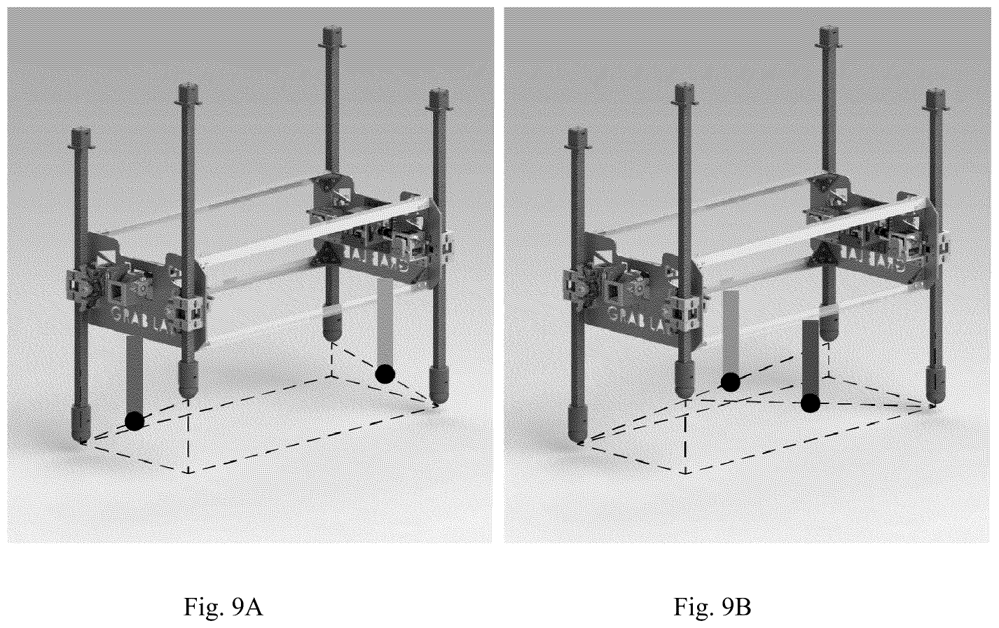

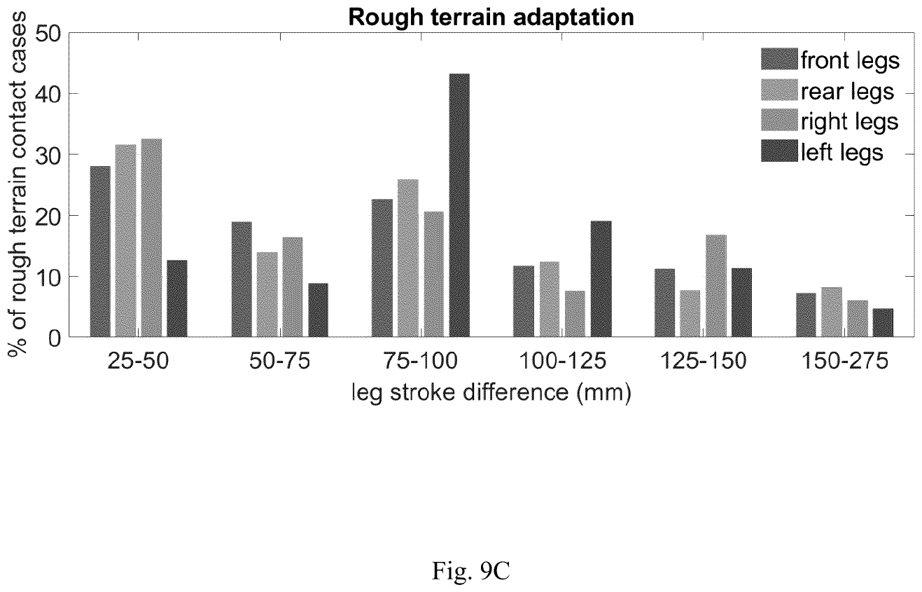

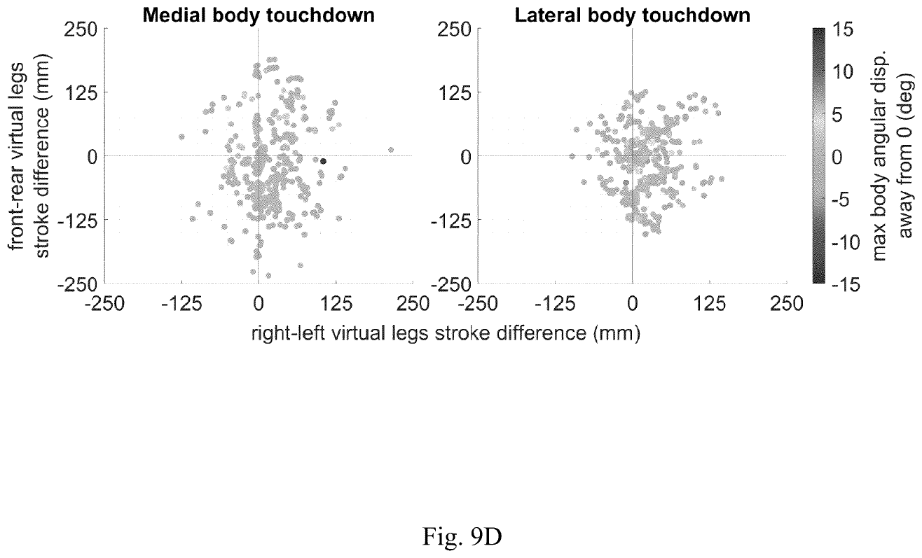

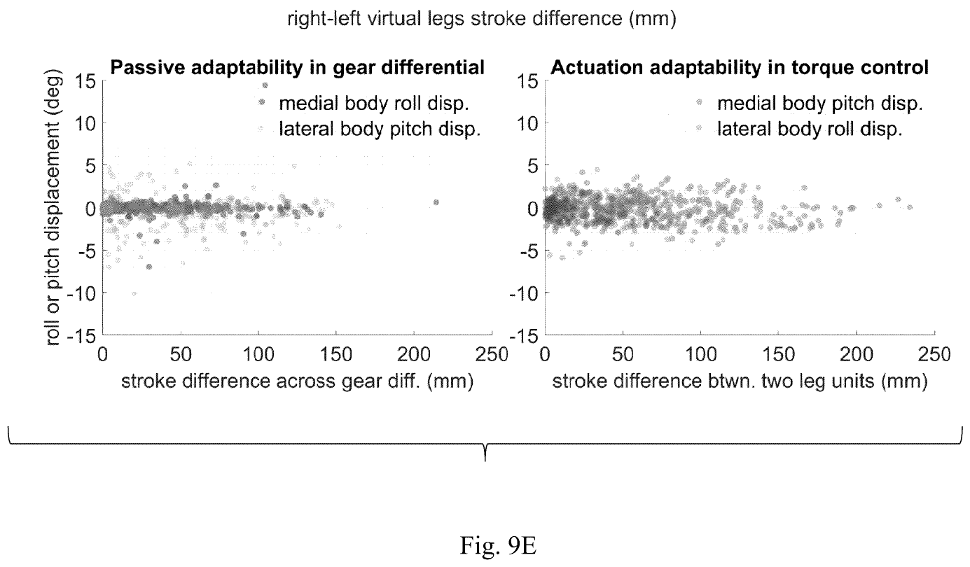

FIGS. 9A-9E present images and several graphs that quantify the passive adaptability of the mechanically intelligent leg units during locomotion. The four leg pairs achieved a wide range of terrain height adaptability during locomotion from a few mm to 262 mm. Terrain adaptability is defined as the leg stroke difference between two legs (see FIGS. 9A & 9B), whether they be physical legs within a mechanically intelligent unit or virtual legs formed by the average of two corresponding legs. Although the locomotion tests took place over the same obstacle course, having a different starting point for each trial resulted in a large distribution of contact cases with differing leg strokes.

FIG. 9A-9E depict the disclosed robots passive adaptability to contact, and body perturbation during contact. FIG. 9A shows virtual legs (in blue) formed by the disclosed mechanically intelligent leg units. FIG. 9B shows virtual legs (in grey) formed by legs on the same sides of gear differentials. FIG. 9C is a plot showing distribution of leg stroke differences upon contact in the four mechanically intelligent leg units during locomotion over an indoor obstacle course. The legs demonstrate passive adaptability to a large range of terrain height differences. FIG. 9D is a plot showing body perturbation as measured by the greater of roll and pitch displacements during touchdown for medial and lateral bodies. Two stance bodies encountered a large range of virtual leg stroke differences in the front-rear and right-left directions, but body angular displacement remained minimal for almost all cases. FIG. 9E is a plot showing body angular displacement in the same plane as the differential motion of corresponding legs or virtual legs during contact. Differential motion of legs across gear differentials in the medial and lateral bodies can induce roll and pitch respectively, and differential motion of legs between mechanically intelligent leg units in the medial and lateral bodies can induce pitch and roll respectively. The lateral body generally experienced greater angular displacement compared to the medial body when considering the differential motion across gear differentials.

Terrain adaptability leverages not only the unconstrained degree of freedom in the gear differentials but also the equal torque control of leg motors. Two leg motors applying equal torque behave as an electronic gear differential during touchdown, and this provides passive adaptability to terrain across two mechanically intelligent leg units. Therefore, passive adaptability exists not only between the two legs of a gear differential but also between two virtual legs, each formed by a pair of differential legs. Then, this property can be quantified by looking at the body rotation caused by ground contact of these legs.

The combined adaptability of the gear differentials and torque-controlled leg motors is plotted in FIG. 9E. Medial body touchdown saw a wider spread in the front-rear virtual leg stroke differences, naturally due to a longer body frame, but the lateral body did not have a wider spread in the right-left virtual leg stroke differences despite being wider. Most contact cases by both bodies saw negligible roll and pitch during touchdown, a clear evidence of high passive adaptability afforded by the gear differentials and torque-controlled leg motors. Occasionally, the robot underwent large body rotations during touchdown when a stance foot slipped off an edge of a concrete block. These situations were inevitable given that no external sensing or footstep planning was utilized, leading to footholds that were not fully within a continuous terrain surface. Severe cases of body rotations that resulted in tip-over during these experiments are not included here, but tip-over cases are recorded and presented in another experimental result for tip-over recovery evaluation.

After this, body rotations during touchdown permitted by gear differentials and torque-controlled motors were compared to quantify the passive adaptability achieved by the two. The gear differentials on the medial and lateral bodies permit roll and pitch motions respectively, and torque control of medial and lateral leg motors permit pitch and roll motions respectively. Virtual leg stroke differences between two leg motors were typically much greater since they span a longer length than virtual legs across gear differentials and are more likely to encounter uneven terrains. Whereas roll and pitch due to torque control had an almost uniform spread from −3 to 3 degrees, pitch due to gear differentials reached larger rotations than roll due to gear differentials. This may be attributed to the robot's center of mass moving from the side of one virtual leg to another as the body translates forward unlike in the case of leg motors where the center of mass always lies between the two virtual legs.

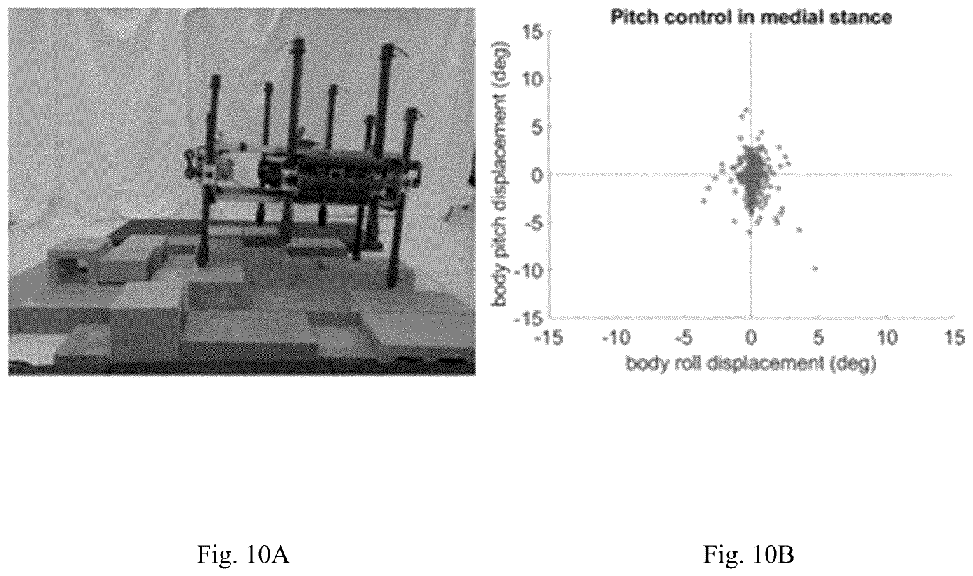

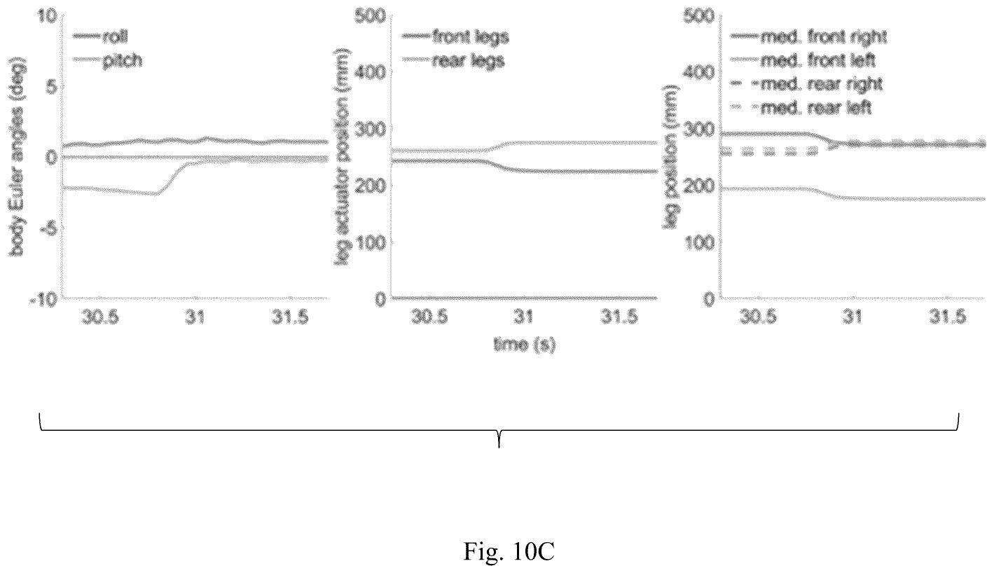

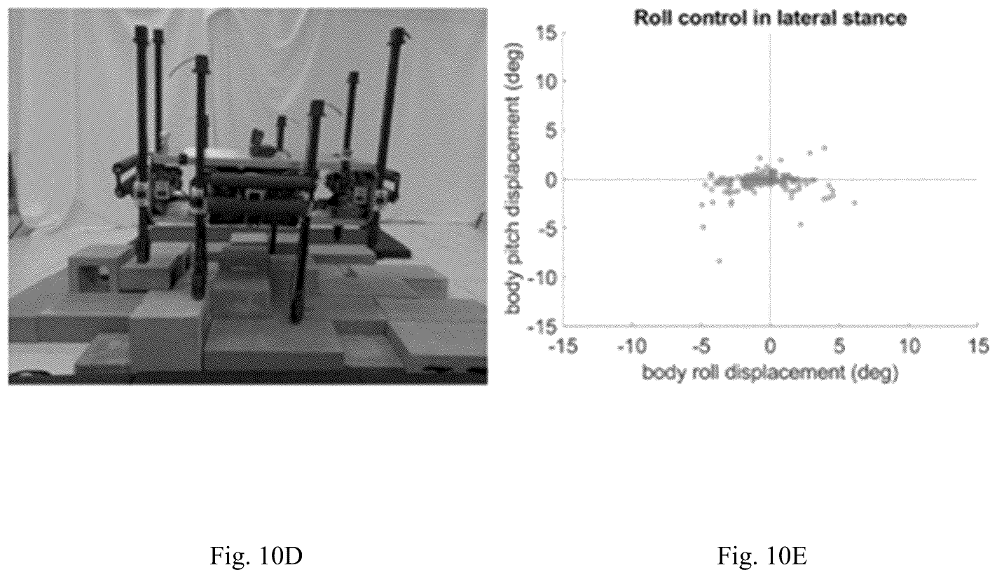

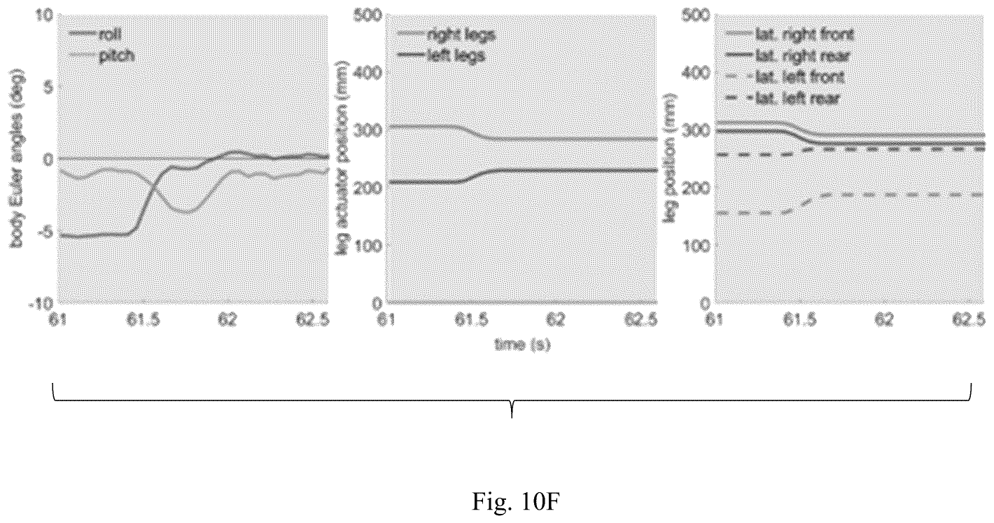

FIGS. 10A-10F show the effects of underactuation on pose regulating motions of the disclosed robot. FIG. 10A is an image of the disclosed robot controlling its pitch while standing on rough terrain. FIG. 10B is a plot showing all cases of pitch control and the accompanied parasitic roll displacement during rough terrain locomotion testing with a vertical spread of the data points. FIG. 10C is a set of plots showing body roll and pitch, leg actuator position and medial body leg trajectories over time during a pitch control maneuver. FIG. 10D is an image of the disclosed robot showing when the body pitch exceeds an allowable value, with the robot controlling its roll while standing on rough terrain. FIG. 10E is a plot showing all cases of roll control and the accompanied parasitic pitch displacement during rough terrain locomotion testing. FIG. 10F is a set of plots showing body roll and pitch, leg actuator position and lateral body leg trajectories over time during a roll control maneuver.

Pose regulation evaluation: The robot maintains a level body posture during locomotion to minimize the lateral load on the vertical prismatic legs and the actuation torque required for forward translation. Although the kinematics of four prismatic legs with rolling contact allow roll, pitch, and vertical translation, controlling them independently is impossible in most configurations with underactuation. Thus, rolling or pitching can induce angular displacement in the other angle if it is even a few degrees away from zero. Motion primitives for pose regulation were implemented into the previously described gait cycle, and the robot was run on the obstacle course to study how effectively the robot can control roll and pitch in various configurations while not tilting over in the other angle. Using the body orientation estimate from an onboard inertial measurement unit (IMU), the robot corrected its pitch using front and rear leg motors during medial body stance and roll using right and left leg motors during lateral body stance.

FIGS. 10A-10F shows the pitch and roll control motion primitives taking place on a rough terrain. A simple actuation strategy of driving the opposing leg pairs in opposite directions could regulate body roll and pitch in various robot configurations. Plotting the angular displacement of desired body rotation against that of undesired body rotation reveals a mostly linear cluster of data points. The robot performed pitch displacement of up to 7 degrees without substantial roll displacement in many cases. As for roll control, most displacements reached up to 5 degrees also with small pitch displacements. Roll control did encounter more instances of large pitch displacements, caused by the center of mass moving with translation.

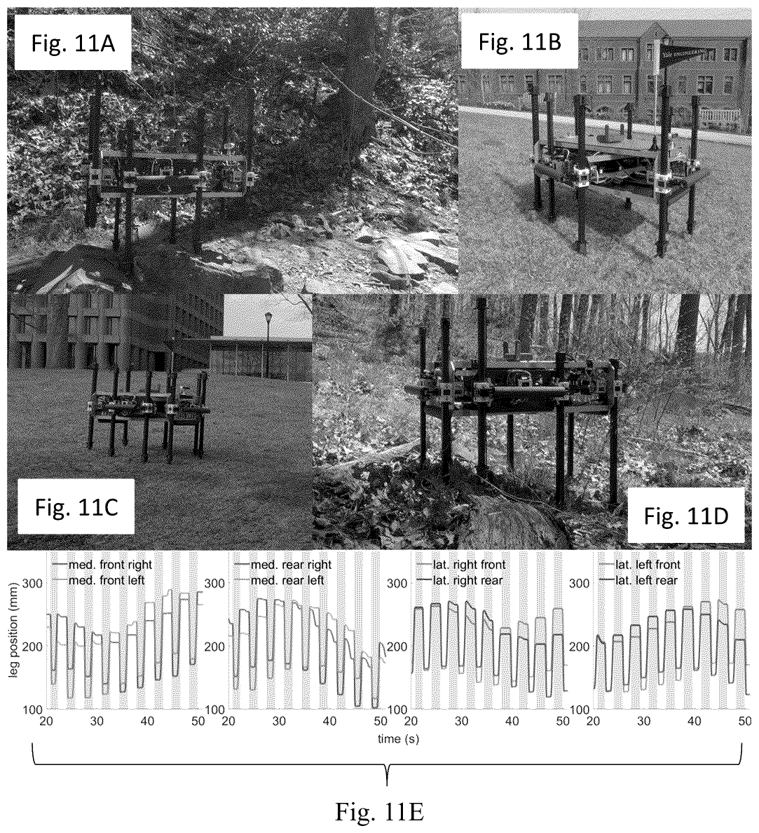

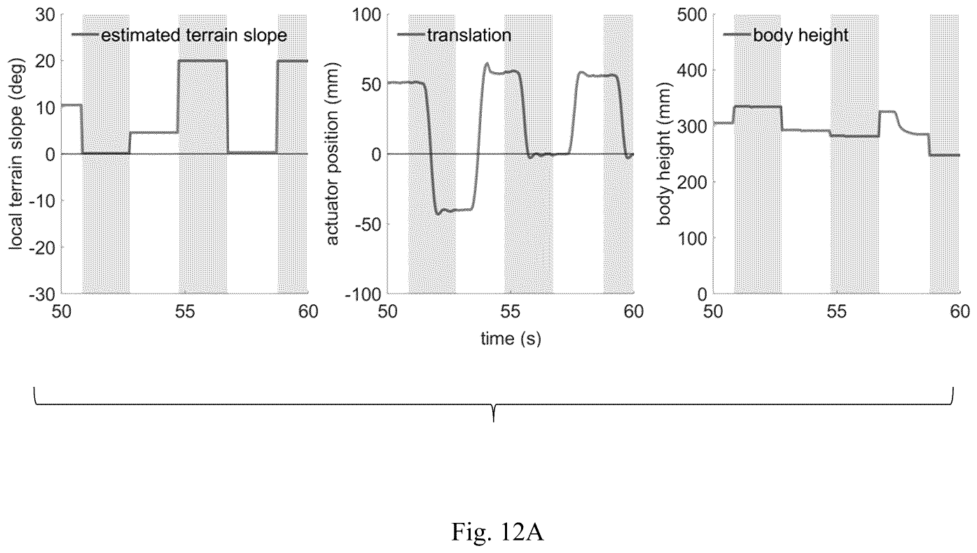

FIGS. 11A-11E are images and correlating plots depicting outdoor locomotion of the disclosed legged robot. FIG. 11A is an image of an exemplary legged robot walking down a grass hill. Because of the downward terrain slope, the robot lowers its body during stance phase to regulate its height. FIG. 11B is an image of a legged robot walking on a hiking trail. Passive adaptability of the prismatic legs allows the body to stand on unknown terrain surfaces and maintain a level body posture during locomotion. FIG. 11C is an image of a legged robot walking in the woods. Sufficient swing leg retraction enables the robot to clear the fallen tree, step over it, and continue walking without knowledge of any obstacles. FIG. 11D is an image Legged robot turning in place. The robot uses its passive adaptability and proprioceptive sensing of its body orientation to stay level while turning in place on a hill. FIG. 11E is a set of plots showing leg position vs time for outdoor locomotion of the legged robot in FIGS. 11A-11D.

Locomotion in outdoor environments: evaluation of the legged robot's locomotion capabilities in outdoor environments took place in multiple settings: a grass hill, a hiking trail, a wooded area covered with soft dirt and a thick layer of leaves. In all outdoor trials, the desired body height, forward translation per step, and swing leg retraction amount were set constant for each environment. In some outdoor trials that demonstrate the turning capability of the robot or that required the robot to follow a path for safety reasons, a user standing nearby provided the heading command for the legged robot using a wireless joystick. In all locomotion tests performed, outdoor or not, the robot did not employ any trajectory or footstep planning. An onboard computing hardware was solely used for communication with the nearby operator and collection of benchmarking data.

FIGS. 11A-11D show the legged robot operating in various outdoor environments described above. Locomotion up and down a grass hill evaluated the combined adaptability of gear differentials and torque-controlled leg motors. This actuation arrangement enabled the front legs and rear legs to adapt to the slope, which manifests itself as different terrain heights along the direction of locomotion. When the lateral body legs touched down, their gear differentials provided passive adaptability to the terrain. Because the robot's forward translation is not parallel to a sloped terrain, its body height over the local terrain increases or decreases with each step. The robot regulated its body height during medial body stance phase when it deviated from the desired body height by more than a given tolerance. On the same hill, the robot was tested for in-place turning capability. Due to the robot's passively adaptive legs, leg trajectories with peaks forming a sinusoidal profile emerged as the robot turned on the slope.

The hiking trail and wooded area presented different challenges to locomotion. The feet frequently slipped on rocks that were angled and covered in sand and dirt. Smaller rocks and pebbles were often displaced under the feet as the robot walked forward. Nonetheless, a statically stable stance formed by four legs maintained the robot's stability, and small body tilts due to foot slippage were addressed by pose regulating motion primitives during their respective stance phase. In the woods, the robot walked over a dense layer of leaves with a layer of soft dirt underneath, causing each foot to sink by varying amounts. At times, the robot executed much larger body angular displacements compared to when walking on the hiking trail to maintain a level posture. Similar to how it passively adapted to the terrain slope on the grass hill, the robot walked over the fallen tree in FIGS. 11A-11D without knowledge of it.

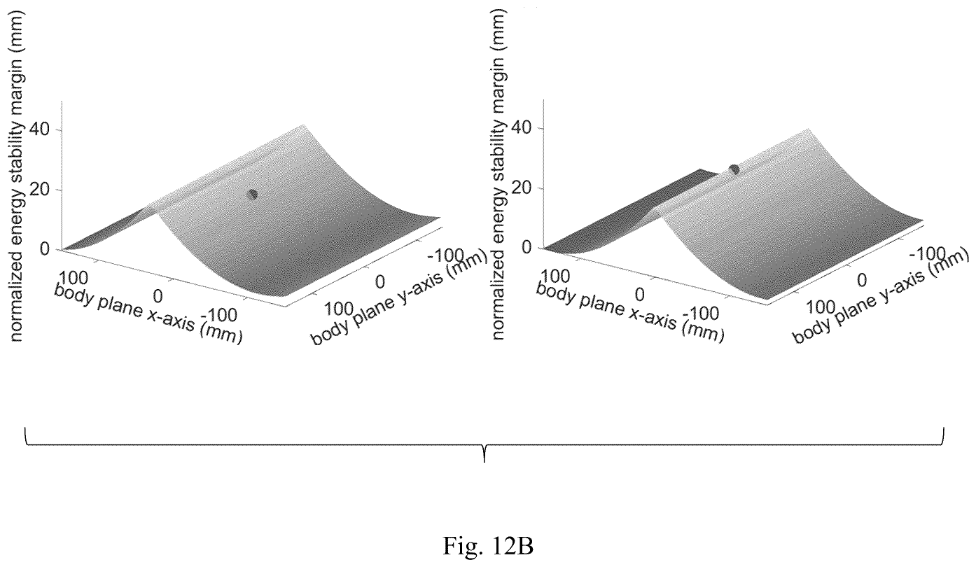

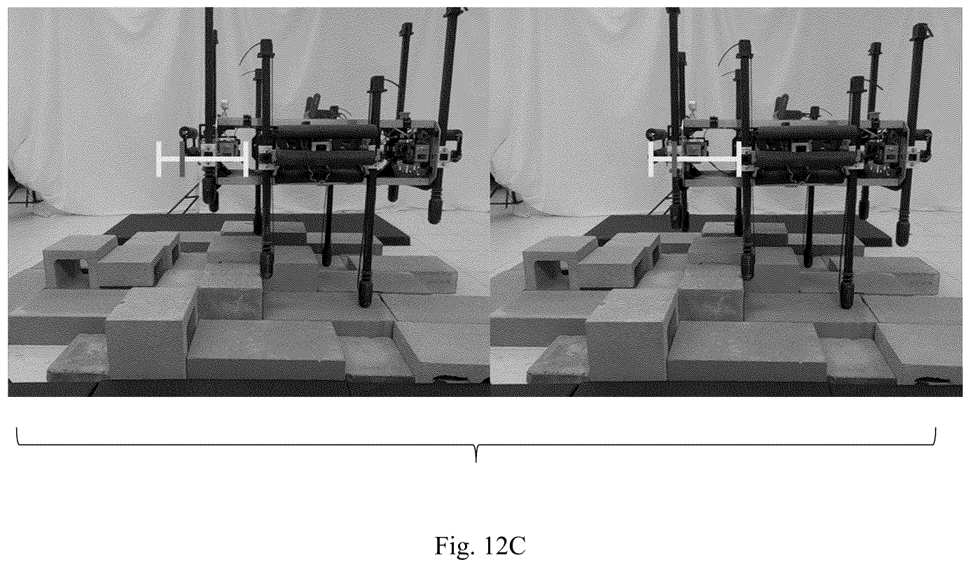

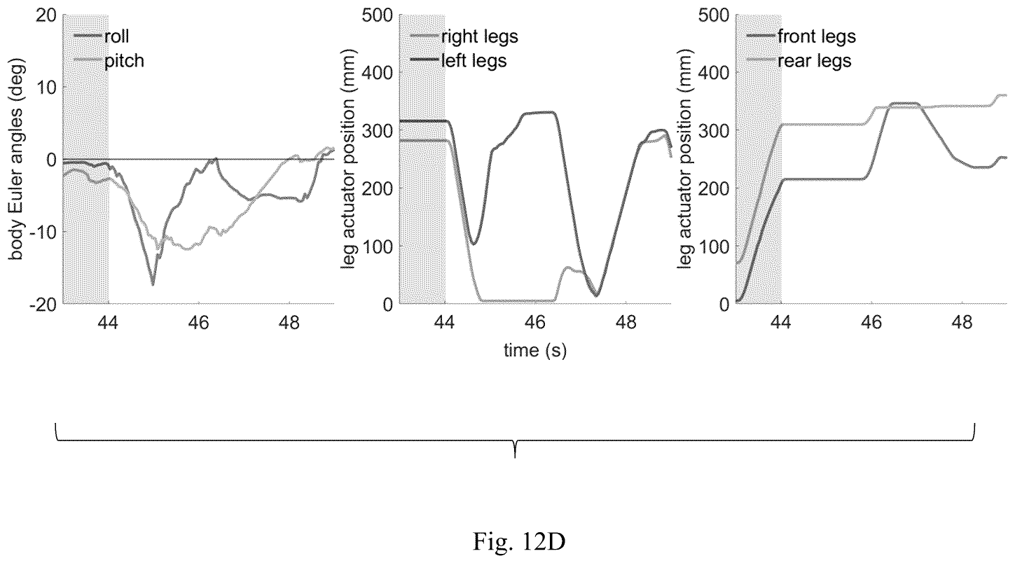

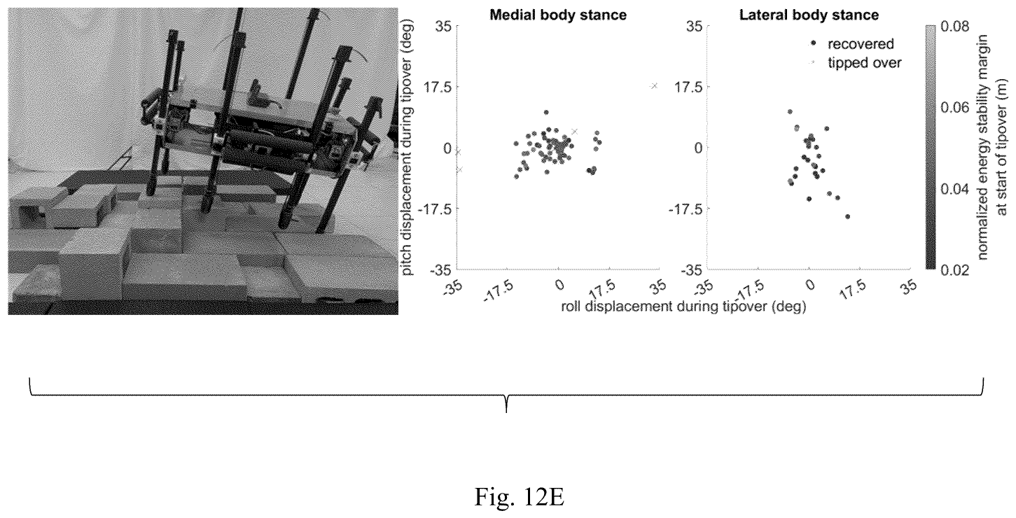

FIGS. 12A-12E are plots and images showing normalized energy stability margin during locomotion and tip-over detection and recovery of the disclosed legged robot. FIG. 12A is a set of plots showing terrain slope estimated through ground contacts, translational joint position and body height over local terrain over time. The range of motion of the translational joint is adjusted with the terrain slope to prevent the normalized energy stability margin of the robot from decreasing too much and tipping over. FIG. 12B is a set of plots showing normalized energy stability margin (NESM) surface of the robot as it translates its body forward (left to right). At the end of the translational motion, the robot configuration reaches the maximum possible stability margin given the current footholds. FIG. 12C is a set of images showing displaying that the front of the robot can translate back and forth within the yellow range. Instead of taking a full step all the way to the left end of the range, the translational motion stops at the red mark to achieve a higher normalized energy stability margin. FIG. 12D is a set of plots showing body Euler angle vs time of the disclosed legged robot. FIG. 12E is an image of the disclosed legged robot (left) and a set of plots showing pitch displacement during tipover over roll displacement during tipover (middle) and NESM at the start of the tipover over roll displacement during tipover (right).

Tip-over recovery: one quantitative metric of static tip-over stability is the normalized energy stability margin (NESM), which can be described as the effective vertical distance the system's center of mass must rise through tipping about two adjacent footholds. The disclosed legged robot maintains its stability margin by adjusting the range of motion of its forward translation based on the current footholds. More specifically, the slope of the local terrain is estimated upon ground contact, and the translational range is shifted to one side accordingly. This locomotion strategy can be seen in FIG. 12C in which the medial body is seen translating only up to a limit imposed by the locomotion controller (red) instead of to the full limit (yellow). This ensures that the robot's configuration does not move past the peak of the NESM surface and drop in stability margin in the current stance phase. This strategy is particularly important in lateral body stance during which the NESM can decrease by over half as the medial body translates forward.

A tip-over recovery behavior was implemented to assess how well the robot can respond to slipping and falling over rough terrain. The recovery behavior consists of a touchdown phase by the legs on the tip-over side as detected by the proprioceptive sensing of the body orientation followed by a tilt control maneuver by the same legs now on the ground to restore the corresponding body Euler angle back to zero. If the robot was in lateral body stance and the translational joint was not centered at the end of the recovery behavior, the robot switched to medial body stance for tip-over stability before resuming normal gait cycle. Timely and accurate detection of a tip-over event was critical to a successful recovery. It was observed in previous experiments that tip-over behaviors typically occurred with a small initial angular velocity at an already tilted configuration or with a large initial angular velocity at a level configuration. Three sets of threshold parameters were determined to detect these slow and fast tip-over events: 4 degrees of body tilt and 25 degrees per second of angular velocity, 6 degrees of body tilt and 12 degrees per second of angular velocity, and 8 degrees of body tilt and 7 degrees per second of angular velocity.

FIGS. 12A-12E depict the disclosed robot responding to a tip-over event on a rough terrain. Lateral body legs were in retraction at the time of the tip-over, and the left legs quickly accelerate in the opposite direction to touch down and catch the fall. Once on the ground, the left legs brought the body roll back to zero before the robot resumed its gait in medial body stance. The figure shows that the same tip-over also caused the body pitch to change rapidly. The combination of large body roll and pitch poses great difficulty in restoring the robot to a level posture using underactuated legs as discussed previously. Preliminary evaluation of an alternate tip-over recovery method using two pairs of stance legs in torque control and a third pair in position control proved to be challenging to generalize for all tip-over cases, especially without any knowledge of ground contacts or possible terrain collision after a tip-over. Therefore, roll and pitch were controlled one after another based on the set of legs on the ground after the robot caught the fall. This actuation strategy can be seen starting at 46 seconds in the plots: after the right legs catch the fall just short of −20 degrees roll, front and rear legs touch down once again to guarantee full ground contact, after which the right legs retract to allow the medial body legs to control the body pitch.

Data of tip-over cases indicate that the robot tended to tip to the left or right in medial body stance and tip to the front or rear in lateral body stance, as expected for their support boundary shapes. A higher normalized energy stability margin at the start of tip-over did not necessarily result in a higher chance of catching the fall. This is because all tip-over cases during the experiments resulted from foot slippage, and a loss of foothold immediately changes the support boundary, thus the normalized energy stability margin. All failed recoveries happened in medial body stance, most of which were tip-overs to the right or left. The robot did not have any failed recoveries in lateral body stance, which most likely benefited from medial body legs catching the falls sooner by being farther out due to the body length. A higher control bandwidth of the legs would have also improved the chances of tip-over recovery in medial body stance as it was observed that a tip-over starting during swing leg retraction was more difficult to recover from.

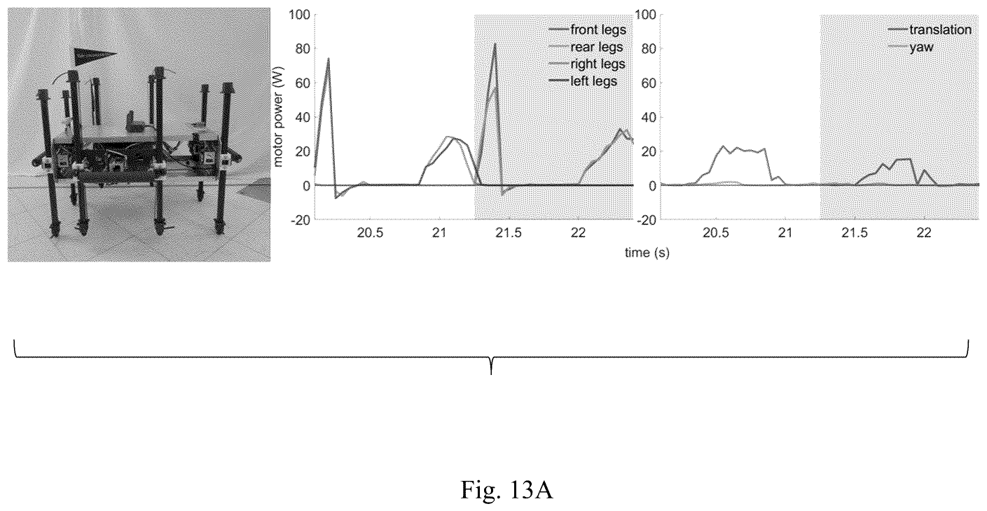

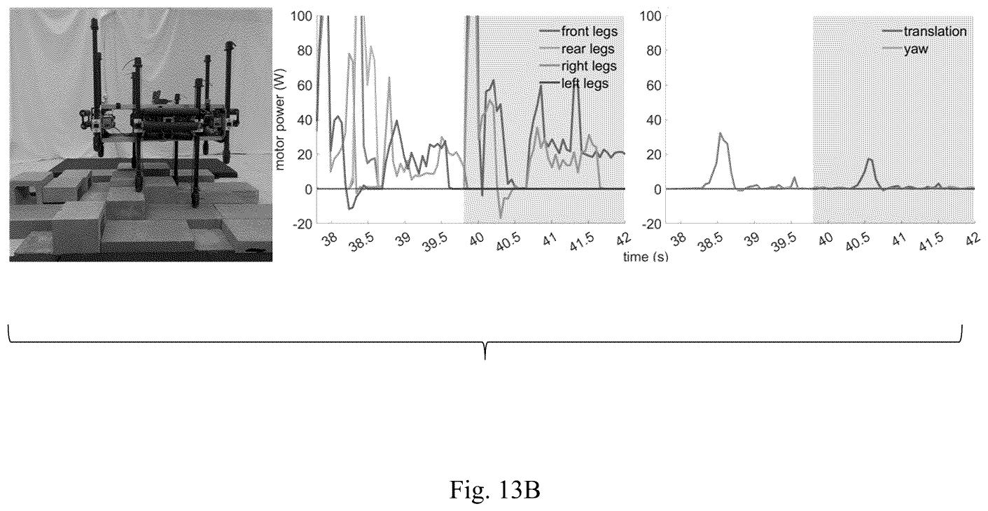

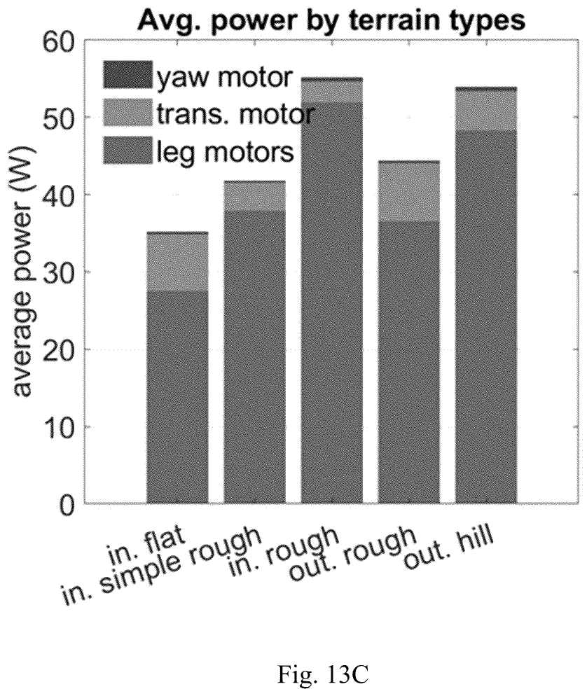

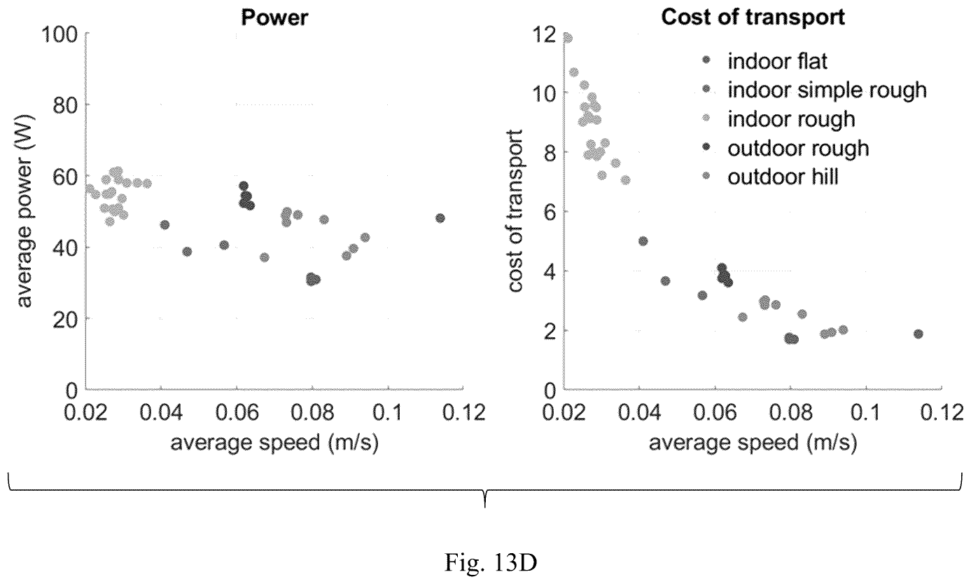

FIGS. 13A-13D are a set of images and plots displaying power characteristics of the disclosed legged robot. FIG. 13A is an image and plots depicting the disclosed legged robot walking on flat terrain (left) with plots displaying power consumption of the leg motors over one gait cycle (middle), and average power consumption of the different motors (right). FIG. 13B is an image and plots depicting the disclosed legged robot walking on rough terrain (left) with plots displaying power consumption of the leg motors over one gait cycle (middle), and average power consumption of the different motors (right) and rough terrains. FIG. 13C is a plot showing average power consumption of different motors for different terrain types. FIG. 13D is a set of plots showing average power consumption (left) and cost of transport (right) of the disclosed robot over different terrains.

In the disclosed example, a gear differential's passive adaptability to contact has been analyzed through direct and indirect metrics such as leg stoke difference upon contact and body angular displacement during touchdown, but a gear differential's reconfiguration due to actuation after contact has not been extensively characterized in this work. The advantage of having an unconstrained degree of freedom during leg touchdown becomes a disadvantage when it permits undesired body rotations during roll and pitch control. This presents an interesting mechanical design problem that requires striking a balance between high passive adaptability and low reconfigurability during actuation. Since the mechanically intelligent leg units use open differentials, utilizing a limited-slip differential similar to that of an automotive transmission may be possible. A lockable differential can completely address the issue of leg reconfiguration during body tilt control, but adding another actuator, though it may be smaller than the leg motor itself, is contrary to the design principle of kinematic underactuation embodied in the disclosed example.

Passively adaptive locomotion: the experimental results indicated that the passively adaptive locomotion strategy presented in this example can successfully tackle a variety of terrains without external sensing. It is also important to underscore that the speed and efficiency of locomotion benefited from some knowledge about the terrain. This allowed for an appropriate choice of actuation and gait parameters that achieved sufficient terrain clearance and stability margin for each terrain type. For example, without any knowledge about the terrain, the robot would have to operate conservatively, fully retracting its legs and minimizing its step length to ensure sufficient swing leg clearance and stability margin. However, this strategy on a smooth, level terrain would unnecessarily sacrifice locomotion speed and power efficiency. Therefore, information about the approximate terrain roughness and slope from external sensing can improve locomotion. It should be remembered, however, that the robot can use external sensing to improve locomotion but does not require it, except for critical information such as the location of a cliff.

Another variable to consider in the passively adaptive locomotion strategy is the leg actuation torque. Tests of mechanically intelligent leg units revealed that a higher leg actuation torque improved the passive adaptability of differentially coupled legs but only up to a limit as excessive torque resulted in large body perturbations. Controlling both leg motors with equal torque during leg touchdown also demonstrated the adaptability of virtual legs across two mechanically intelligent leg units. While both types of adaptability manifest themselves as equal torque outputs to two legs or virtual legs, a more in-depth comparison of the two will be needed, controlling for the total system inertia and the span across the two legs. The effects of passively adaptive leg actuation on the duration of leg touchdown and the overall locomotion will need to be considered as well.

Vertical prismatic legs: vertical prismatic legs provide a simple one degree-of-freedom solution to standing on uneven terrains and have several advantages. Their instantaneous vertical reach is not configuration-dependent like a link with a revolute joint, and this property simplifies their motion planning in swing. On mostly level contact surfaces, vertical prismatic legs can more easily produce a smoother vertical force profile and minimize the chance of slipping compared to an articulated leg. And despite having no articulation at the shoulder, the legs can generate roll and pitch motions through rolling contacts at the feet. Another important characteristic of the legs is their compact volume compared to articulated legs. This enables collision-free leg touchdown in environments clustered with obstacles in which an articulated leg may have challenge operating.

There are a few considerations in realizing a physical implementation of vertical prismatic legs. At a higher roll or pitch angle, a prismatic leg experiences a large lateral load at the linear bearing whereas an articulated leg can operate such that the effective moment arm about each of the three axes is much shorter. This corresponds to large pitch and yaw moment loads in terms of a linear rail specification. An early prototype of the leg used a steel ball bearing linear rail to satisfy the requirement of large moment loads and surface hardness, but the high weight budget for each leg led to the current design with a carbon fiber tube and a custom designed ball bearing. Having lightweight legs like other legged robots in the literature and with a high surface hardness to withstand the large lateral loads is paramount to a successful, long-term operation. The vertical prismatic legs in the disclosed legged robot also differ from other articulated legs in that they protrude above the body when retracted. This can hinder the robot's operation in confined environments with obstacles above the robot. A prismatic leg mechanism that is more compact upon retraction would resolve this limitation.

Non-transparent leg actuation: the disclosed legged robot's prismatic legs are non-backdrivable because of the worm gear driving each leg's timing belt pulley. This is a stark contrast to many other legged robots that employ actuation transparency, generally defined as the ability to estimate contact forces with adequate accuracy using actuator feedback. Transparent actuation typically features a direct-drive or a low gear ratio transmission in leg actuation, making the legs backdrivable. Having non-backdrivable legs limits ground contact detection to only during actuation since the leg motors do not have to work to hold the robot's weight, but this has not hindered the robot's performance in more dynamic maneuvers such as tip-over recovery because actuating the legs immediately enables contact detection again.

Composition of perpendicular translations for locomotion: decomposition of leg motion into vertical and horizontal translations through a task-oriented design naturally led to the analysis of individual joint trajectories. Separation of terrain adaptation and propulsion means that the dynamics of the prismatic legs and locomotion mechanism can also be separated. Nevertheless, its unique mechanical design does not preclude more dynamic locomotion through improved coordination of these degrees of freedom. Better contact detection, higher actuator bandwidth, and model-based control can increase the performance of disclosed legged robot just like other legged robots.

Geometry of medial and lateral bodies: the fixed distance between prismatic legs has several implications for locomotion. First, each stance body's projected support boundary remains constant. This simplifies motion planning of the forward translation because tip-over stability can be inferred using a rough estimate of the terrain slope through contacts. However, this design also prohibits the robot from establishing an arbitrary set of footholds even if they are all individually within reach. As a result, locomotion in environments with narrow or sparsely located surfaces may be a challenge. Lastly, the ratio of body length to leg length determines the maximum negotiable terrain slope. A shorter medial body can stand on a steeper slope while a longer medial body increases the maximum step length, though limited by the stability margin.

Power characteristics: locomotion with a level posture and propulsion of the robot body through translation in space creates a unique scaling of power consumption with the robot weight. A heavier weight would only increase the power consumption of leg motors during actuation in stance and of the forward translation motor as it accelerates and decelerates one body relative to the other. Thanks to the non-backdrivability of the prismatic legs, the leg motors do not consume any power in stance if not actuated. This has two major advantages for a mobile robot: the total power consumption scales much more favorably than that of a robot that needs to consume power to support its weight, and the robot can stand indefinitely without power, resulting in power savings during tasks requiring the robot to stay still.

Prismatic leg: in some embodiments, each prismatic leg is a 24-inch long, square carbon fiber tube with 0.75-inch inner width manufactured by DragonPlate. A custom linear bearing comprising eight 624-2RS ball bearings was designed for the leg. To mitigate angular play in the bearing caused by the tube's manufacturing tolerance on the outer dimensions, adhesive-back stainless steel shim stocks with a thickness 0.006 inch and 0.008 inch were added as needed to tubes with smaller dimensions. A grip tape manufactured by CatTongue was applied to the four outer sides of the tubes to prevent the bearings from damaging the tube surface over time.

In some embodiments, each leg is driven by 3 mm pitch GT timing belt pulley with a pitch diameter of 19.101 mm. In some embodiments, the open timing belt is 9 mm wide and 840 mm long and clamped on both ends of the tube. In some embodiments, two idler rollers enclose the belt around the pulley, and two additional idler rollers keep the belt parallel to the leg as it moves. In some embodiments, a 1.5 inch-long compression spring with a stiffness of 60 lbs./in. mounted above the foot aids in leg extension when the belt tension rises at the joint limit due to underactuation. In some embodiments, the leg uses a 1⅝ inch diameter nitrile rubber knob for its spherical foot.

Gear differential and actuator: a gear differential is a single-input dual-output mechanism that allows for a differential motion between the two outputs. In some embodiments, each gear differential comprises four carbon steel, spiral miter gears of module 1 and 20-tooth manufactured by KHK. Two right-handed gears are the output gears, and two left-handed gears are the spider gears of the differential. In some embodiments, the input gear of the differential is a hubless spur gear of module 0.8 and 30-tooth bonded with Loctite 638 to the differential carrier. In some embodiments, a brushless motor with a stall torque of 1.25 Nm and speed constant of 330 Kv drives the gear differential with a spur gear of module 0.8 and 60-tooth. In some embodiments, a second gear identical to the input gear bridges the gap between the motor axis and the differential axis.

Worm gearbox: among several variables affecting the backdrivability of a worm gear, the lead angle of a worm is one of the most critical design variables. Theoretically, a worm gear is not backdrivable if the friction angle is greater than the worm lead angle. However, the effective coefficient of friction between the worm and worm wheel depends on several parameters such as the sliding velocity of the gear, lubrication type, gear materials and surface wear conditions. Typically, the lead angle decreases with increasing gear ratio and worm pitch diameter, hence the common association of a large gear ratio to non-backdrivability.

In some embodiments, each pair of prismatic legs has a right-handed and left-handed worm drive for motion in the same direction upon actuation by the gear differential. In some embodiments, the worms are carbon steel, module 1.25 and double lead with a lead angle of 6050′ and a pitch diameter of 21 mm. In some embodiments, the worm wheels are bronze and 20-tooth with a pitch diameter of 25.18 mm. In some embodiments, an 8 mm worm shaft connects to the gear differential output with a flexible shaft coupler. In some embodiments, the 6 mm worm wheel shaft is stepped to support the 0.25 inch bore of the timing belt pulley.

Locomotion mechanism: in some embodiments, a central carriage assembly holds the two gimbal motors that actuate the relative translation and rotation of two bodies. In some embodiments, the translation actuator drives a rack and pinion to move the carriage assembly on two 400 mm linear rails mounted along the medial body. In some embodiments, the yaw actuator drives a spur gear to rotate the lateral body relative to the central carriage and the medial body. In some embodiments, the central carriage holds a face-mount cross-roller bearing by the outer race, and the lateral body mounts to the inner race to rotate about the carriage.

Leg touchdown control: in some embodiments, leg touchdown begins with a high startup torque, followed by a lower torque command for the remaining motion. In some embodiments, a motor torque command of 0.1 to 0.12 Nm was used for locomotion on flat terrains and 0.14 to 0.16 Nm was used on rough terrains. In some embodiments, after contact was detected for both prismatic legs, the leg motor was set to idle.

Body tilt and height control: a two-dimensional simplified model of the stance body kinematics was used for roll and pitch control.

Sensing and control hardware: the hardware on the disclosed legged robot comprises a computing device (e.g., an NVIDIA (R) Jetson Orin (TM) development board), which provides the necessary sensing, high-level computing, and communication capabilities. In some embodiments, the sensing comprises an RGB-D camera, an Intel (R) RealSense (TM) D435, whereas the communication of a wireless access point which utilizes the standard wireless communication TCP/IP protocol stack (i.e., 802.11) for interoperability with existing network devices. In some embodiments, the high-level computing device (e.g., development board) interfaces a microcontroller, (e.g., Teensy (R) 4.0), utilizing the UART interface on one end, and the access point utilizing the ethernet interface on the other. In some embodiments, the sensing and communication devices are mounted on the medial body, whereas the high-level computing device and the microcontroller are positioned internally in the lateral body. The sensing is utilized for benchmarking and subsequent visualization purposes and is not used to aid the locomotion which solely relies on the concept of mechanically intelligent legs. Basic functionalities such as visual simultaneous localization and mapping and exploratory path planning are provided. All the necessary high-level control and sensing software components are implemented in ROS and ROS2 middleware and operate in real-time onboard the disclosed legged robot, whereas additional processing can be performed through the ROS network.

In some embodiments, low-level control is implemented in C/C++ on the microcontroller, and the communication with the motor drives and encoders relies on the controller area network (CAN) bus protocol. In some embodiments, both low- and high-level controls work independently, i.e., the disclosed legged robot comes to a full stop if the high-level computing board encounters an anomaly. In some embodiments, additional redundancy is achieved with the CAN protocol, whereas other safety mechanisms, such as wired control, are implemented.

Teleoperation: to control the disclosed legged robot, in some embodiments, a human operator connects to the access point's provided network using a portable computer or a smartphone. In some embodiments, the access point relays the communication to the computing hardware, which runs an HTTP server. In some embodiments, a high-level communication framework, implemented in PHP, JavaScript, and HTML and accessible via a web browser, allows the operator to select the desired position and attitude using a simulated joystick and stores the commands internally. In some embodiments, the commands are parsed and transferred to the microcontroller utilizing a customized synchronous communication protocol based on a fixed window size communication methodology. Conflicts are handled directly by the communication framework, and priority is given to the newest command. In some embodiments, if there are two operators teleoperating the robot at the same time, the one who sends the last command within the current communication window is transferred.

Additionally to the communication framework, external and application control is possible via the ROS network and a standard ROS interface. In some embodiments, external ROS components transfer the position and attitude commands utilizing ROS topics, which are handled internally by the framework and transferred to the microcontroller using the custom communication protocol. Teleoperation based on the provided framework and access point is limited to short distances, usually with the human operator being directly in the line of sight of the robot. However, support for long-range teleoperation is provided, utilizing past work based on the LoRa, low-power, long-range communication methodology from the internet-of-things domain.

The disclosures of each and every patent, patent application, and publication cited herein are hereby each incorporated herein by reference in their entirety. While this invention has been disclosed with reference to specific embodiments, it is apparent that other embodiments and variations of this invention may be devised by others skilled in the art without departing from the true spirit and scope of the invention. The appended claims are intended to be construed to include all such embodiments and equivalent variations.

What is claimed is:

1. A legged robot system, comprising:
a medial body having first and second ends, slidably and rotatably attached to a lateral body having first and second ends via a locomotion mechanism configured to provide at least first and second degrees of freedom of movement for the lateral body relative to the medial body;
a plurality of prismatic legs comprising first and second legs extending downward from positions on the first or second ends of the lateral or medial bodies, each leg comprising a drive mechanism for extending the leg, wherein the first leg provides a third degree of freedom relative to its position on the lateral or medial body, and the second leg provides a fourth degree of freedom relative to its position on the lateral or medial body; and
a differential mechanism connecting the first and second legs providing a fifth degree of freedom of movement for the first and second leg relative to each other.

2. The system of claim 1, wherein the locomotion mechanism slidably and rotatably attaches a central portion of the medial body to a central portion of the lateral body.

3. The system of claim 1, wherein the first degree of freedom is rotational, and the second degree of freedom is translational.

4. The system of claim 1, wherein the third and fourth degrees of freedom are translational.

5. The system of claim 1, wherein the fifth degree of freedom is translational or rotational.

6. The system of claim 1, wherein the first, second, third and fourth degrees of freedom are constrained, and the fifth degree of freedom is unconstrained.

7. The system of claim 1, wherein the differential mechanism comprises an input shaft and first and second output shafts.

8. The system of claim 7, further comprising a first motor connected to the input shaft of the differential mechanism.

9. The system of claim 8, further comprising a pair of non-backdrivable worm gearboxes, wherein a first worm gearbox connects the first output shaft of the differential mechanism to the drive mechanism of the first leg, and a second worm gearbox connects the second output shaft of the differential mechanism to the drive mechanism of the second leg.

10. The system of claim 9, wherein each non-backdrivable worm gearbox comprises an actuator configured to selectively actuate the non-backdrivability of the worm gearbox.

11. The system of claim 10, wherein the differential mechanism comprises an electronically controlled limited-slip differential (LSD).

12. The system of claim 11, wherein the first leg is configured to be at least partially actuated separately from the second leg.

13. The system of claim 12, wherein the first leg comprises a drive belt extending along at least a portion of a length of the first leg.

14. The system of claim 13, wherein the drive mechanism comprises a drive gear for driving the drive belt.

15. The system of claim 14, wherein the drive mechanism comprise an idler gear for aligning and tensioning the drive belt.

16. The system of claim 15, wherein the first leg has a bottom compliant foot.

17. The system of claim 1, wherein the locomotion mechanism comprises a rack and pinion coupled to a rotatable gear, wherein the rack and pinion is configured to provide the translational movement, and the rotatable gear is configured to provide the rotational movement.

18. The system of claim 17, further comprising a second motor connected to the rack and pinion configured to actuate the rack and pinion, and a third motor connected to the rotatable gear configured to actuate the rotatable gear.

19. The system of claim 18, wherein the first, second and third motors each comprise one or more sensors selected from the group consisting of position sensor, speed sensor, power sensor, and torque sensor.

20. The system of claim 19, further comprising a computing device communicatively connected to the first, second and third motors, and the one or more sensors, the computing device configured to actuate the motors and capture signals from each of the one or more sensors.
